(19) United States
(12) Patent Application Publication
(10) Pub. No.: US 2025/0282958 A1
(43) Pub. Date: Sep. 11, 2025

(54) Curable Photochromic Composition Including a Segmented Polymer

(71) Applicant: Transitions Optical, Ltd., Tuam (IE)

(72) Inventors: Feng Wang, Export, PA (US); Michael Frank Haley, Glenshaw, PA (US); Stephen G. Robinson, Murrysville, PA (US); Emily Amond, Allison Park, PA (US)

(21) Appl. No.: 18/861,338

(22) PCT Filed: Apr. 29, 2022
(86) PCT No.: PCT/EP2022/061451

§ 371 Date: Oct. 29, 2024

(51) Int. Cl. C09D 5/29; C09D 175/04; C09D 183/14; G02B 1/10

(52) U.S. Cl. CPC C09D 5/29; C09D 175/04; C09D 183/14; G02B 1/10

(57) ABSTRACT

The present invention relates to, a curable photochromic composition that includes a photochromic compound, a trialkoxysilane functional material having at least two trialkoxysilane groups, and a segmented polymer that includes at least one first segment, and at least one second segment. Each first segment, of the segmented polymer, independently includes a (meth)acrylic polymer segment, and/or a fluoroethylene vinyl ether polymer segment. Each second segment, of the segmented polymer, independently includes, a polycarbonate segment, a polyester segment, a polyether segment, a polyurethane segment, or combinations thereof. The present invention also relates to an article that includes: a substrate; and a photochromic layer over at least one surface of the substrate, where the photochromic layer is formed from the curable photochromic composition of the present invention.

### FIELD

The present invention relates to curable photochromic compositions, which include a photochromic compound, a trialkoxysilane functional material having at least two trialkoxysilane groups, and a segmented polymer that includes at least one first segment, and at least one second segment.

### BACKGROUND

In response to certain wavelengths of electromagnetic radiation (or “actinic radiation”), photochromic compounds, such as indeno-fused naphthopyrans, typically undergo a transformation from one form or state to another form, with each form having a characteristic or distinguishable absorption spectrum associated therewith. Typically, upon exposure to actinic radiation, many photochromic compounds are transformed from a closed-form, which corresponds to an unactivated (or bleached, e.g., substantially colorless) state of the photochromic compound, to an open-form, which corresponds to an activated (or colored) state of the photochromic compound. In the absence of exposure to actinic radiation, such photochromic compounds are reversibly transformed from the activated (or colored) state, back to the unactivated (or bleached) state. Compositions and articles, such as optical lenses, that contain photochromic compounds or have photochromic compounds applied thereto (e.g., in form of a photochromic coating composition) typically display colorless (e.g., clear) and colored states that correspond to the colorless and colored states of the photochromic compounds contained therein or applied thereto.

Photochromic compounds can be used in curable compositions to form, for example, cured layers, such as cured films or sheets that are photochromic. With cured photochromic films, such as cured photochromic coatings, it is typically desirable that they provide a combination of hardness and photochromic performance. Generally, the kinetics associated with the reversible transformation of a photochromic compound between a closed-form (unactivated/colorless) and an open-form (activated/colored) is faster in a soft matrix, but slower in a hard matrix (of the cured film in which the photochromic compound resides). Cured photochromic films having a soft matrix typically have reduced hardness, while those having a hard matrix typically have increased hardness.

It would be desirable to develop curable photochromic compositions that provide cured photochromic layers having improved hardness without a reduction in photochromic performance.

### SUMMARY

In accordance with the present invention, there is provided a curable photochromic composition comprising: (a) a photochromic compound; (b) a trialkoxysilane functional material having at least two trialkoxysilane groups; and (c) a segmented polymer comprising, at least one first segment, and at least one second segment. Each first segment, of the segmented polymer, independently comprises at least one of a (meth)acrylic polymer segment, or a fluoroethylene vinyl ether polymer segment. Each second segment, of the segmented polymer, independently comprises at least one of, a polycarbonate segment, a polyester segment, a polyether segment, or a polyurethane segment.

In accordance with the present invention, there is further provided an article comprising: (A) a substrate; and (B) a photochromic layer over at least one surface of the substrate, wherein the photochromic layer is formed from the curable photochromic composition of the present invention, as described above.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### DETAILED DESCRIPTION

As used herein, the articles “a,” “an,” and “the” include plural referents unless otherwise expressly and unequivocally limited to one referent.

Unless otherwise indicated, all ranges or ratios disclosed herein are to be understood to encompass any and all values, and subranges or subratios subsumed therein. For example, a stated range or ratio of “1 to 10” should be considered to include: any and all values there-between, including the stated terminal values (such as, 1, 2, 3, 4, 5, 6, 7, 8, 9, and 10); and subranges between (and inclusive of) the minimum value of 1 and the maximum value of 10, that is, all subranges or subratios beginning with a minimum value of 1 or more and ending with a maximum value of 10 or less, such as but not limited to, 1 to 6.1, 3.5 to 7.8, and 5.5 to 10.

As used herein, unless otherwise indicated, left-to-right representations of linking groups, such as divalent linking groups, are inclusive of other appropriate orientations, such as, but not limited to, right-to-left orientations. For purposes of non-limiting illustration, the left-to-right representation of the divalent linking group

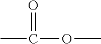

or equivalently —C(O)O—, is inclusive of the right-to-left representation thereof,

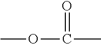

or equivalently —O(O)C— or —OC(O)—.

Other than in the operating examples, or where otherwise indicated, all numbers expressing quantities of ingredients, reaction conditions, and so forth used in the specification and claims are to be understood as modified in all instances by the term “about.”

As used herein, molecular weight values of polymers, such as weight average molecular weights (Mw) and number average molecular weights (Mn), are determined by gel permeation chromatography (GPC) using appropriate standards, such as polystyrene standards.

As used herein, polydispersity index (PDI) values represent a ratio of the weight average molecular weight (Mw) to the number average molecular weight (Mn) of the polymer (i.e., Mw/Mn).

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means methacrylates and/or acrylates. As used herein, the term “(meth)acrylic acid” means methacrylic acid and/or acrylic acid.

As used herein, the term “photochromic” and similar terms, such as “photochromic compound” means having an absorption spectrum for at least visible radiation that varies in response to absorption of at least actinic radiation. Further, as used herein the term “photochromic material” means any substance that is adapted to display photochromic properties (such as, adapted to have an absorption spectrum for at least visible radiation that varies in response to absorption of at least actinic radiation) and which includes at least one photochromic compound.

As used herein, the term “actinic radiation” means electromagnetic radiation that is capable of causing a response in a material, such as, but not limited to, transforming a photochromic material from one form or state to another as will be discussed in further detail herein.

As used herein, the term “transmittance percentage” and related terms, such as “transmission percentage” and “% T,” refers to photopic transmission, and more specifically means the fraction of incident electromagnetic power (or radiation) in the visible spectrum (wavelength of 390 nm to 700 nm) that is transmitted through a body, such as an optical element (e.g., a display element), multiplied by 100 (so as to provide a percentage). For purposes of non-limiting illustration, and in accordance with some embodiments, the transmittance percentage is determined by: passing light from a light source through a body, and recording a first intensity value using a spectrophotometer; passing light from the same light source through a blank (such as, in the absence of a body) and recording a second intensity value using the same spectrophotometer; and dividing the first intensity value by the second intensity value, and multiplying the fractional result by 100. The transmittance percentage, % T, can be represented by the following Equation 1 (Eq. 1):

$$\% T = ( P / {P}_{0} ) \times 100 \qquad ( Eq . l )$$

With reference to Eq. 1, P is the intensity of light after passing through the body, and P₀ is the intensity of the same light after passing through the blank. The Examples, as provided further herein, describe methods for measuring the transmittance percentage.

As used herein, the term “photochromic material” includes thermally reversible photochromic materials and compounds and non-thermally reversible photochromic materials and compounds. The term “thermally reversible photochromic compounds/materials” as used herein means compounds/materials capable of converting from a first state, for example a “clear state,” to a second state, for example a “colored state,” in response to actinic radiation, and reverting back to the first state in response to thermal energy. The term “non-thermally reversible photochromic compounds/materials” as used herein means compounds/materials capable of converting from a first state, for example a “clear state,” to a second state, for example a “colored state,” in response to actinic radiation, and reverting back to the first state in response to actinic radiation of substantially the same wavelength(s) as the absorption(s) of the colored state.

As used herein to modify the term “state,” the terms “first” and “second” are not intended to refer to any particular order or chronology, but instead refer to two different conditions or properties. For purposes of non-limiting illustration, the first state and the second state of a photochromic compound can differ with respect to at least one optical property, such as but not limited to the absorption of visible and/or UV radiation. Thus, according to various non-limiting embodiments disclosed herein, the photochromic compounds of the present invention can have a different absorption spectrum in each of the first and second states. For example, while not limiting herein, a photochromic compound of the present invention can be clear in the first state and colored in the second state. Alternatively, a photochromic compound of the present invention can have a first color in the first state and a second color in the second state.

As used herein the term “optical” means pertaining to or associated with light and/or vision. For example, according to various non-limiting embodiments disclosed herein, the optical article or element or device can be chosen from ophthalmic articles, elements and devices, display articles, elements and devices, windows, mirrors, and active and passive liquid crystal cell articles, elements and devices.

As used herein the term “ophthalmic” means pertaining to or associated with the eye and vision. Non-limiting examples of ophthalmic articles or elements include corrective and non-corrective lenses, including single vision or multi-vision lenses, which can be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors.

As used herein the term “display” means the visible or machine-readable representation of information in words, numbers, symbols, designs or drawings. Non-limiting examples of display elements include screens, monitors, and security elements, such as security marks.

As used herein the term “window” means an aperture adapted to permit the transmission of radiation there-through. Non-limiting examples of windows include automotive and aircraft transparencies, windshields, filters, shutters, and optical switches.

As used herein the term “mirror” means a surface that specularly reflects a large fraction of incident light.

As used herein the term “liquid crystal cell” refers to a structure containing a liquid crystal material that is capable of being ordered. A non-limiting example of a liquid crystal cell element is a liquid crystal display.

As used herein, spatial or directional terms, such as “left”, “right”, “inner”, “outer”, “above”, “below”, and the like, relate to various orientations of the invention as may be described further herein, such as articles and multilayer articles of the present invention. It is to be understood, however, that the invention can assume various alternative orientations to those described herein and, accordingly, such terms are not to be considered as limiting.

As used herein, the terms “formed over,” “deposited over,” “provided over,” “applied over,” residing over,” or “positioned over,” mean formed, deposited, provided, applied, residing, or positioned on but not necessarily in direct (or abutting) contact with the underlying element, or surface of the underlying element. For example, a layer “positioned over” a substrate does not preclude the presence of one or more other layers, coatings, or films of the same or different composition located between the positioned or formed layer and the substrate.

All documents, such as but not limited to issued patents and patent applications, referred to herein, and unless otherwise indicated, are to be considered to be “incorporated by reference” in their entirety.

As used herein, recitations of “linear or branched” groups, such as linear or branched alkyl, are herein understood to include: a methylene group or a methyl group; groups that are linear, such as linear C₂-C₂₀ alkyl groups; and groups that are appropriately branched, such as branched C₃-C₂₀ alkyl groups.

The term “alkyl” as used herein means linear or branched, cyclic or acyclic C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl. Examples of alkyl groups from which the various alkyl groups of the present invention can be selected from, include, but are not limited to, those recited further herein. Alkyl groups can include “cycloalkyl” groups. The term “cycloalkyl” as used herein means groups that are appropriately cyclic, such as, but not limited to, C₃-C₁₂ cycloalkyl (including, but not limited to, cyclic C₃-C₁₀ alkyl, or cyclic C₅-C₇ alkyl) groups. Examples of cycloalkyl groups include, but are not limited to, those recited further herein. The term “cycloalkyl” as used herein also includes: bridged ring polycycloalkyl groups (or bridged ring polycyclic alkyl groups), such as, but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein means groups that are appropriately cyclic, such as, but not limited to, C₂-C₁₂ heterocycloalkyl groups, such as C₂-C₁₀ heterocycloalkyl groups, such as C₅-C₇ heterocycloalkyl groups, and which have at least one hetero atom in the cyclic ring, such as, but not limited to, O, S, N, P, and combinations thereof. Examples of heterocycloalkyl groups include, but are not limited to, imidazolyl, tetrahydrofuranyl, tetrahydropyranyl and piperidinyl. The term “heterocycloalkyl” as used herein also includes: bridged ring polycyclic heterocycloalkyl groups, such as, but not limited to, 7-oxabicyclo[2.2.1]heptanyl; and fused ring polycyclic heterocycloalkyl groups, such as, but not limited to, octahydrocyclopenta[b]pyranyl, and octahydro-1H-isochromenyl.

The descriptions, classes, and examples provided herein with regard to alkyl groups, cycloalkyl groups, heterocycloalkyl groups, haloalkyl groups, and the like, are also applicable to alkane groups, cycloalkane groups, heterocycloalkane groups, haloalkane groups, etc., such as, but not limited to, polyvalent alkane groups, such as polyvalent alkane linking groups, such as divalent alkane linking groups.

As used herein, the term “aryl” and related terms, such as “aryl group”, means an aromatic cyclic monovalent hydrocarbon radical. As used herein, the term “aromatic” and related terms, such as “aromatic group,” means a cyclic conjugated hydrocarbon having stability (due to delocalization of pi-electrons) that is significantly greater than that of a hypothetical localized structure. Examples of aryl groups include C₆-C₁₄ aryl groups, such as, but not limited to, phenyl, naphthyl, phenanthryl, and anthracenyl.

The term “heteroaryl”, as used herein, includes, but is not limited to, C₃-C₁₈ heteroaryl, such as, but not limited to, C₃-C₁₀ heteroaryl (including fused ring polycyclic heteroaryl groups) and means an aryl group having at least one hetero atom in the aromatic ring, or in at least one aromatic ring in the case of a fused ring polycyclic heteroaryl group. Examples of heteroaryl groups include, but are not limited to, furanyl, pyranyl, pyridinyl, quinolinyl, isoquinolinyl, and pyrimidinyl.

The term “aralkyl”, as used herein, includes, but is not limited to, C₆-C₂₄ aralkyl, such as, but not limited to, C₆-C₁₀ aralkyl, and means an alkyl group substituted with an aryl group. Examples of aralkyl groups include, but are not limited to, benzyl and phenethyl.

Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl and decyl. Representative alkenyl groups include, but are not limited to, vinyl, allyl, and propenyl. Representative alkynyl groups include, but are not limited to, ethynyl, 1-propynyl, 2-propynyl, 1-butynyl, and 2-butynyl. Representative cycloalkyl groups include, but are not limited to, cyclopropyl, cyclobutyl, cyclopentyl, cyclohexyl, and cyclooctyl.

The term “nitrogen-containing heterocycle,” such as “nitrogen-containing heterocycle group” or nitrogen-containing heterocycle substituent”, as used herein, includes, but is not limited to, a nitrogen-containing ring in which the nitrogen-containing ring is bonded through a ring nitrogen. Examples of nitrogen-containing heterocycles include, but are not limited to, aliphatic cyclic aminos (or cycloaliphatic aminos), such as morpholino, piperidino, pyrrolidino, and decahydroisoquinolino; and heteroaromatics, such as imidazole, pyrrole, indole, and carbazole.

As used herein, the term “halo” and related terms, such as “halo group,” “halo substituent,” “halogen group,” and “halogen substituent,” means a single bonded halogen group, such as —F, —Cl, —Br, and —I.

As used herein, recitations of “halo substituted” and related terms (such as, but not limited to, haloalkyl groups, haloalkenyl groups, haloalkynyl groups, haloaryl groups, and halo-heteroaryl groups) means a group in which at least one, and up to and including all of the available hydrogen groups thereof is substituted with a halo group, such as, but not limited to F, Cl or Br. The term “halo-substituted” is inclusive of “perhalo-substituted.” As used herein, the term perhalo-substituted group and related terms (such as, but not limited to, perhaloalkyl groups, perhaloalkenyl groups, perhaloalkynyl groups, perhaloaryl groups or perhalo-heteroaryl groups) means a group in which all of the available hydrogen groups thereof are substituted with a halo group. For purposes of non-limiting illustration: perhalomethyl is —CX₃; and perhalophenyl is —C₆X₅, where X represents one or more halo groups, such as, but not limited to F, Cl, Br, or I.

As used herein, “at least one of” is synonymous with “one or more of,” whether the elements are listed conjunctively or disjunctively. For example, the phrases “at least one of A, B, and C” and “at least one of A, B, or C” each mean any one of A, B, or C, or any combination of any two or more of A, B, or C. For example, A alone; or B alone; or C alone; or A and B; or A and C; or B and C; or all of A, B, and C.

As used herein, “selected from” is synonymous with “chosen from” whether the elements are listed conjunctively or disjunctively. Further, the phrases “selected from A, B, and C” and “selected from A, B, or C” each mean any one of A, B, or C, or any combination of any two or more of A, B, or C. For example, A alone; or B alone; or C alone; or A and B; or A and C; or B and C; or all of A, B, and C.

As used herein, and in accordance with some embodiments, the term “ketone” such as with regard to groups, and substituents of various groups, of the compounds and components of the present invention, and related terms, such as “ketone group” and “ketone substituent,” includes a material represented by —C(O)R, where R is selected from those groups as described below, other than hydrogen.

As used herein, and in accordance with some embodiments, the term “carboxylic acid” such as with regard to groups, and substituents of various groups, of the compounds and components of the present invention, and related terms, such as “carboxylic acid group” and “carboxylic acid substituent” includes a material represented by —C(O)OH.

As used herein, and in accordance with some embodiments, the term “ester” such as with regard to groups, and substituents of various groups, of the compounds and components of the present invention, and related terms, such as “ester group” and “ester substituent” means a carboxylic acid ester group represented by —C(O)OR, where R is selected from those groups as described below, other than hydrogen.

As used herein, and in accordance with some embodiments, the term “carboxylate” such as with regard to groups, and substituents of various groups, of the compounds and components of the present invention, and related terms, such as “carboxylate group” and “carboxylate substituent,” includes a material represented by —OC(O)R, where R is selected from those groups as described below.

As used herein, and in accordance with some embodiments, the term “amide” such as with regard to groups, and substituents of various groups, of the compounds and components of the present invention, and related terms, such as “amide group” and “amide substituent” includes a material represented by —C(O)N(R)(R) or —N(R)C(O)R, where each R is independently selected from those groups as described below.

As used herein, and in accordance with some embodiments, the term “carbonate” such as with regard to groups, and substituents of various groups, of the compounds and components of the present invention, and related terms, such as “carbonate group” and “carbonate substituent” includes a material represented by —OC(O)OR, where R is selected from those groups as described below, other than hydrogen.

As used herein, and in accordance with some embodiments, the term “carbamate” and related terms, such as “urethane,” such as with regard to groups, and substituents of various groups, of the compounds and components of the present invention, and related terms, such as “carbamate group,” “carbamate substituent,” “urethane group,” and “urethane substituent,” includes a material represented by —OC(O)N(R)(H) or —N(H)C(O)OR, where R in each case is independently selected from those groups as described below, other than hydrogen.

As used herein, and in accordance with some embodiments, the term “urea” such as with regard to groups, and substituents of various groups, of the compounds and components of the present invention, and related terms, such as “urea group” and “urea substituent” includes a material represented by —N(R)C(O)N(R)(R), where each R is independently selected from those groups as described below.

As used herein, and in accordance with some embodiments, the term “siloxy” such as with regard to groups, and substituents of various groups, of the compounds and components of the present invention, and related terms, such as “siloxy group” and “siloxy substituent” includes a material represented by —O—Si(R)₃ where each R is independently selected from those groups as described below, other than hydrogen.

As used herein, and in accordance with some embodiments, the term “alkoxysilane” such as with regard to groups, and substituents of various groups, of the compounds and components of the present invention, and related terms, such as “alkoxysilane group” and alkoxysilane substituent” includes a material represented by —Si(OR″)_{w}(R)ₜ, where w is 1 to 3 and t is 0 to 2, provided the sum of w and t is 3; R″ for each w is independently selected from alkyl; and R for each t is independently selected from those groups as described below, other than hydrogen.

As used herein, and in accordance with some embodiments, the term “polysiloxane” such as with regard to groups, and substituents of various groups, of the compounds and components of the present invention, and related terms, such as “polysiloxane group” and “polysiloxane substituent”, includes a material represented by the following Formula (A):

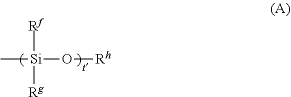

With reference to Formula (A): t′ is greater than or equal to 2, such as from 2 to 200; R^{f} and R^{g} for each t′ are each independently selected from a group R as described below, other than hydrogen; and R^{h} is independently a group R as described below.

Unless otherwise stated, each R group of each of the above described ketone, ester (carboxylic acid ester), carboxylate, amide, carbonate, carbamate, urea, siloxane, alkoxysilane groups, and polysiloxane groups, is in each case independently selected from hydrogen, alkyl, haloalkyl, perhaloalkyl, cycloalkyl, heterocycloalkyl, aryl, heteroaryl, and combinations thereof (including those classes and examples thereof as recited previously herein).

The photochromic compositions of the present invention include a trialkoxysilane functional material having at least two trialkoxysilane groups. The trialkoxysilane functional material, with some embodiments, has from 2 to 7 trialkoxysilane groups, or from 2 to 5 trialkoxysilane groups, or from 2 to 4 trialkoxysilane groups. The trialkoxysilane groups can each independently be trimethoxysilane groups or triethoxysilane groups.

The trialkoxysilane functional material with some embodiments, is free of aromatic groups. With some further embodiments, the trialkoxysilane functional material includes one or more of the following linkages: ether linkages (—O—); thioether linkages (—S—); urea linkages (—N(R)—C(O)—N(R)—, where each R is independently as described above); carbonate linkages (—O—C(O)—O—); carboxylic acid ester linkages (—O—C(O)—); urethane linkages (—N(H)—C(O)—O—); thiourethane linkages (—S—C(O)—N(H)—); thiourea linkages (—N(R)—C(S)—N(R)—, where each R is independently as described above); and amide linkages (—C(O)—N(R)—, where R is as described above).

With some embodiments, the trialkoxysilane functional material is represented by the following Formula (I),

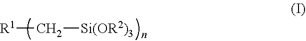

With reference to Formula (I), n is at least 2, such as from 2 to 7, or from 2 to 6, or from 2 to 5, or from 2 to 4, or from 2 to 3, in each case inclusive of the recited values. With further reference to Formula (I), R² is, in each case, independently methyl or ethyl. With additional reference to Formula (I), R¹ includes at least one of: a polyvalent aliphatic hydrocarbon residue; a polyvalent aliphatic ether residue; a polyvalent aliphatic urethane residue; a polyvalent aliphatic carboxylic acid ester residue; a polyvalent aliphatic carbonate residue; or combinations of two or more thereof. The polyvalent aliphatic hydrocarbon residue, the polyvalent aliphatic ether residue, the polyvalent aliphatic urethane residue, the polyvalent aliphatic carboxylic acid ester residue, and the polyvalent aliphatic carbonate residue, in each case independently have a valency of n (or a valency that is equal to n).

As used herein, the term “aliphatic hydrocarbon” means a hydrocarbon, which can be linear or branched, and/or cyclic, and which is free of aromatic groups. With some embodiments, the polyvalent aliphatic hydrocarbon residue is selected from linear or branched alkyl, such as linear or branched C₁-C₂₀ alkyl, or cycloalkyl, such as C₃-C₁₀ cycloalkyl.

With some embodiments, R¹ of Formula (I) includes at least one of polyvalent aliphatic hydrocarbon residue, polyvalent aliphatic urethane residue, polyvalent aliphatic carbonate residue, or combinations of two or more thereof.

As used herein, the term “aliphatic ether” means an ether including at least one ether linkage (—O—), which can be linear or branched, and/or cyclic, and which is free of aromatic groups. The polyvalent aliphatic ether residue includes, with some embodiments, 1 to 20, or 1 to 15, or 1 to 10, or 1 to 8, or 1 to 5, or 1 to 4, or 1 to 3 ether linkages. With some further embodiments, the polyvalent aliphatic ether residue includes a linear or branched C₁-C₂₀ alkyl linkage and/or a C₃-C₁₀ cycloalkyl linkage, independently between and/or extending from each ether linkage.

As used herein the term “aliphatic urethane” means a urethane including at least one urethane linkage (—O—C(O)—N(H)—), which can be linear or branched, and/or cyclic, and is free of aromatic groups. The polyvalent aliphatic urethane residue includes, with some embodiments, 1 to 20, or 1 to 15, or 1 to 10, or 1 to 8, or 1 to 5, or 1 to 4, or 1 to 3 urethane linkages. With some further embodiments, the polyvalent aliphatic urethane residue includes a linear or branched C₁-C₂₀ alkyl linkage and/or a C₃-C₁₀ cycloalkyl linkage independently between and/or extending from each urethane linkage.

As used herein, the term “aliphatic carboxylic acid ester” means a carboxylic acid ester including at least one carboxylic acid ester linkage (—C(O)—O—), which can be linear or branched, and/or cyclic, and is free of aromatic groups. The polyvalent aliphatic carboxylic acid ester residue includes, with some embodiments, 1 to 20, or 1 to 15, or 1 to 10, or 1 to 8, or 1 to 5, or 1 to 4, or 1 to 3 carboxylic acid ester linkages. With some further embodiments, the polyvalent aliphatic carboxylic acid ester residue includes a linear or branched C₁-C₂₀ alkyl linkage and/or a C₃-C₁₀ cycloalkyl linkage independently between and/or extending from each carboxylic acid ester linkage.

As used herein, the term “aliphatic carbonate” means a carbonate including at least one carbonate linkage (—O—C(O)—O—), which can be linear or branched, and/or cyclic, and is free of aromatic groups. The polyvalent aliphatic carbonate residue includes, with some embodiments, 1 to 20, or 1 to 15, or 1 to 10, or 1 to 8, or 1 to 5, or 1 to 4, or 1 to 3 carbonate linkages. With some further embodiments, the polyvalent aliphatic carbonate residue includes a C₁-C₂₀ alkyl linkage and/or a C₃-C₁₀ cycloalkyl linkage, independently between and/or extending from each carbonate linkage.

Examples of trialkoxysilane functional materials having at least two trialkoxysilane groups, that can be used in the curable photochromic compositions of the present invention include, but are not limited to: 1,1-bis(trimethoxysilylmethyl)ethylene; 1,6-bis(trimethoxysilyl)hexane; 1,8-bis(trimethoxysilyl)octane, 1,10-bis(trimethoxysilyl)decane; 1,6-bis(trimethoxysilyl)2,5-dimethylhexane; N,N′-bis[(3-trimethoxysilyl)propyl)ethylenediamine; bis(3-trimethoxysilylpropyl)amine; bis(3-trimethoxysilylpropyl)-N-methylamine; N-(hydroxyethyl)-N,N-bis(trimethoxysilylpropyl)amine; tris(3-trimethoxysilylpropyl)isocyanurate; bis(3-trimethoxysilylpropyl)fumarate; N,N′-bis(3-trimethoxysilylpropyl)thiourea; tetrakis-{3-[2-trimethoxysilylethyl)tetramethyldisiloxanylpropxy]methyl}methane; and combinations of two or more thereof.

The trialkoxy functional material of the curable photochromic compositions of the present invention, can be prepared in accordance with art-recognized methods. With some embodiments, the trialkoxy functional material can be prepared from the reaction of an isocyanate functional trialkoxysilane reactant, such as an isocyanatoalkyl trialkoxysilane, with an active hydrogen functional reactant having at least two active hydrogen groups, such as hydroxyl, thiol, and/or primary amine groups. With some embodiments, the active hydrogen functional reactant has an active hydrogen equivalent weight of less than or equal to 500 g/mole. Examples of isocyanate functional trialkoxysilane reactants include, but are not limited to: 3-isocyanatopropyl trimethoxysilane; 3-isocyanatopropyl triethoxysilane; isocyanatomethyl trimethoxysilane; and isocyanatomethyl triethoxysilane.

Examples of polyols from which the active hydrogen functional reactant can be selected, include, but are not limited to aliphatic polyols and/or cycloaliphatic polyols, such as: ethylene glycol; diethylene glycol; propylene glycol; 1,3-propanediol; 1,2-butanediol; 1,4-butanediol; neopentyl glycol; 2-methyl-1,3-propanediol; glycerol; trimethylolpropane; ditrimethylolpropane; pentaerythritol; dipentaerythritol; erythritol; meso-erythritol; xylitol; sorbitol; 1,4-cyclohexane diol; 1,3-cyclohexane diol; or 1,2-cyclohexane diol; cyclohexane triol, for example, 1,3,5-cyclohexane triol or 1,2,3-cyclohexane triol; cyclohexane tetrol; cyclohexane pentol; cyclohexane hexol; cyclopentane diol, for example, 1,3-cyclopentane diol or 1,2-cyclopentane diol; and heterocyclic aliphatic polyols such as 1,3,5-tris(2-hydroxyethyl)isocyanurate. With some embodiments, the polyol reactant has a hydroxyl equivalent weight of less than or equal to 500 g/mole.

The active hydrogen functional reactant, with some embodiments, includes one or more of: aliphatic polyether polyols; aliphatic polyester polyols; aliphatic polycarbonate polyols; and aliphatic polycarbonate-polyester polyols.

Examples of polyamines from which the active hydrogen functional reactant can be selected include, but are not limited to: linear or branched C₂-C₆ alkanediamines; diethylenetriamine; branched polyethylene imines; polyether diamines; and polyether triamines. Polyether diamines and polyether triamines are commercially available under the tradename JEFFAMINE polyether amines. With some embodiments, the polyamine reactant has an amine equivalent weight of 500 g/mole.

Examples of polythiols from which the active hydrogen functional reactant can be selected include, but are not limited to: 1,2-ethanedithiol; 1,2-propanedithiol; 1,3-propanedithiol; 1,2,3-propanetrithiol; bis(2-mercaptoethyl) sulfide; trimethylolpropane tris(3-mercaptopropionate); and pentaerythritol tetrakis(3-mercaptopropionate).

With some embodiments, the trialkoxysilane functional material is prepared from the reaction of a polyisocyanate reactant having at least two isocyanate groups, and an amine functional trialkoxysilane, such as an aminoalkyl trialkoxysilane. Examples of polyisocyanate reactants include, but are not limited to, those polyisocyanate materials recited further herein. Examples of amine functional trialkoxysilane reactants include, but are not limited to: 3-aminopropyltrimethoxysilane; 4-amino-3,3-dimethylbutyltrimethoxysilane; N-(2aminoethyl)-3-aminopropyltrimethoxysilane; N-(2-aminoethyl)-3-aminopropyltriethoxysilane; N-(6-aminohexyl) aminopropyltrimethoxysilane.

With some embodiments, the trialkoxysilane functional material is prepared from the reaction of a polyisocyanate reactant having at least two isocyanate groups, and a thiol (or mercapto; —SH) functional trialkoxysilane, such as a thioalkyl trialkoxysilane (or mercaptoalkyl trialkoxysilane). Examples of polyisocyanate reactants include, but are not limited to, those polyisocyanate materials recited further herein. Examples of thiol functional trialkoxysilane reactants include, but are not limited to: (3-mercaptopropyl)trimethoxysilane; and (3-mercaptopropyl)triethoxysilane.

The trialkoxysilane functional material, with some embodiments is prepared by a Michael addition/reaction involving: an amine functional trialkoxysilane reactant or a thiol functional trialkoxysilane reactant; and an acrylate functional reactant having at least two acrylate groups. Classes and examples of amine functional trialkoxysilane and thiol functional trialkoxysilane reactants include those classes and examples recited previously herein. Examples of acrylate functional reactants include, but are not limited to: alkyleneglycol diacrylates, such as ethyleneglycol diacrylate and neopentyl glycol diacrylate; and timethyloltriacylate.

The trialkoxysilane functional material, with some embodiments is prepared by a Michael addition/reaction involving: a polyamine reactant having at least two amine groups or a polythiol reactant having at least two thiol groups; and an acrylate functional trialkoxysilane reactant. Classes and examples of polyamine and polythiol reactants include those classes and examples recited previously herein. A non-limiting class of acrylate functional trialkoxysilane reactants include (trialkoxysilane)alkyl acrylates, such as 3-(trimethoxysilyl)propyl acrylate.

The trialkoxysilane functional material having at least two trialkoxysilane groups, with some embodiments, is present in the curable photochromic composition of the present invention in an amount of from 50 to 85 percent by weight, or from 50 to 80 percent by weight, or from 60 to 75 percent by weight, the percent weights in each case being based on total weight of resin solids of the curable photochromic composition, and inclusive of the recited values.

As used herein, and with regard to the curable photochromic composition, the term “total weight of resin solids” and similar terms, such as “total resin solids weight” and “total resin solids” means the total weight of the trialkoxysilane functional material and the segmented polymer, and with some further embodiments, does not include the weight of the photochromic compound(s) or other optional additives.

In accordance with some embodiments, the trialkoxysilane functional material comprises Si in an amount of from 5.0 to 16.0 percent by weight, or from 6.0 to 14.0 percent by weight, or from 7.0 to 13.0 percent by weight, the percent weights in each case being based on solids weight of the trialkoxysilane functional material. The amount of Si is determined, with some embodiments, by NMR analysis or mass spectrometry analysis of the trialkoxysilane functional material, or calculation from the chemical formula.

In accordance with some further embodiments, a weight ratio of the trialkoxysilane functional material to the segmented polymer is from 80:15 to 50:50, or from 80:20 to 50:50, or from 75:25 to 60:40.

The photochromic compositions of the present invention include a segmented polymer that includes, (i) at least one first segment, and (ii) at least one second segment. Each first segment independently includes at least one of a (meth)acrylic polymer segment, and/or a fluoroethylene vinyl ether polymer segment.

The (meth)acrylic monomers from which the (meth)acrylic polymer segment of each first segment can independently be prepared include, but are not limited to, C₁-C₂₀ (meth)acrylates and optionally C₁-C₂₀ (meth)acrylates having at least one active hydrogen group selected from hydroxyl, thiol, primary amine, and secondary amine. The C₁-C₂₀ groups of the (meth)acrylates can be selected from, for example, C₁-C₂₀ linear alkyl, C₃-C₂₀ branched alkyl, C₃-C₂₀ cycloalkyl, C₃-C₂₀ fused ring polycycloalkyl, C₅-C₂₀ aryl, and C₁₀-C₂₀ fused ring aryl.

Examples of C₁-C₂₀ (meth)acrylates (that are free of functional groups, such as hydroxyl, thiol, primary amine, and secondary amine groups) from which each (meth)acrylic polymer segment of each first segment can be independently prepared include, but are not limited to, methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, 2-ethylhexyl (meth)acrylate, lauryl (meth)acrylate, isobornyl (meth)acrylate, cyclohexyl (meth)acrylate and 3,3,5-trimethylcyclohexyl (meth)acrylate.

With some embodiments, the C₁-C₂₀ (meth)acrylates having at least one active hydrogen group are each independently selected from C₁-C₂₀ (meth)acrylates having at least one hydroxyl group. Examples of C₁-C₂₀ (meth)acrylates having at least one active hydrogen group selected from hydroxyl, from which each (meth)acrylic polymer segment of each first segment can be independently prepared include, but are not limited to, 2-hydroxyethyl (meth)acrylate, hydroxypropyl (meth)acrylate, hydroxybutyl (meth)acrylate, hydroxycyclohexyl (meth)acrylate, 6-hydroxyhexyl(meth)acrylate and 12-hydroxydodecyl (meth)acrylate.

With some embodiments, hydroxyl groups are introduced into the (meth)acrylic polymer segment of the first segment, after its formation. For purposes of non-limiting illustration, the (meth)acrylic polymer segment of the first segment can be prepared from monomers including (meth)acrylic monomers having oxirane functionality. The oxirane functional (meth)acrylic monomer residues or units can be hydrolyzed or reacted with monofunctional alcohols after polymerization to form hydroxy functional (meth)acrylic monomer residues or units. Examples of oxirane functional (meth)acrylates from which the (meth)acrylic polymer segment of the first segment can be prepared, include, but are not limited to, glycidyl (meth)acrylate, 3,4-epoxycyclohexylmethyl(meth)acrylate, and 2-(3,4-epoxycyclohexyl)ethyl (meth)acrylate.

With some embodiments, the (meth)acrylic polymer segment of each first segment, in addition to (meth)acrylate monomers, is prepared from additional ethylenically unsaturated radically polymerizable monomers (that are other than (meth)acrylate monomers), such as (meth)acrylic acid, vinyl aromatic monomers, vinyl esters of carboxylic acids, and/or other ethylenically unsaturated monomers that are radically polymerizable.

Examples of vinyl aromatic monomers that can be used to form the (meth)acrylic polymer segment of the first segment include, but are not limited to, styrene, p-chloromethylstyrene, divinyl benzene, vinyl naphthalene, and divinyl naphthalene.

Examples of vinyl esters of carboxylic acids that can be used to form the (meth)acrylic polymer segment of the first segment include, but are not limited to, vinyl acetate, vinyl butyrate, vinyl 3,4-dimethoxybenzoate, and vinyl benzoate.

Examples of other ethylenically unsaturated monomers that are radically polymerizable that can be used to form the (meth)acrylic polymer segment of the first segment include, but are not limited to: cyclic anhydrides, such as maleic anhydride, 1-cyclopentene-1,2-dicarboxylic anhydride and itaconic anhydride; esters of acids that are unsaturated but do not have alpha, beta-ethylenic unsaturation, such as methyl ester of undecylenic acid; and diesters of ethylenically unsaturated dibasic acids, such as diethyl maleate.

With some embodiments, the (meth)acrylic polymer segment of each first segment, is prepared from radically polymerizable monomers that are selected only from: (meth)acrylate monomers, such as C₁-C₂₀ (meth)acrylates and optionally C₁-C₂₀ (meth)acrylates having at least one active hydrogen group selected from hydroxyl, thiol, primary amine, and secondary amine; and optionally (meth)acrylic acid.

The (meth)acrylic polymer segment of each first segment, can be prepared by art-recognized polymerization methods, including, but not limited to, free radical polymerization methods, and living radical polymerization methods, such as atom transfer radical polymerization methods.

The (meth)acrylic polymer segment of each first segment, can have any suitable polymer chain (or backbone) architecture, such as: random polymer chain architecture; block polymer chain architecture; alternating polymer chain architecture; and gradient polymer chain architecture.

The (meth)acrylic polymer segment of each first segment, can have any suitable gross architecture, and as such can be selected from, for example, a linear (meth)acrylic polymer segment and/or a branched (meth)acrylic polymer segment. With some embodiments, the (meth)acrylic polymer segment of each first segment is a linear (meth)acrylic polymer segment.

The (meth)acrylic segment of each first segment, can have any suitable molecular weight. With some embodiments, the (meth)acrylic segment of each first segment independently has a Mn of at least 1000, such as an Mn of 1000 to 15,000; and an Mw of at least 2000, such as a Mw of from 2000 to 30,000.

Each first segment independently includes, with some embodiments, a fluoroethylene vinyl ether polymer segment. With some embodiments, each fluoroethylene vinyl ether polymer segment is a fluoroethylene-alkyl vinyl ether alternating polymer (or copolymer) segment. The fluoroethylene monomer, used to prepare the fluoroethylene vinyl ether polymer segment, with some embodiments, includes chlorotrifluoroethylene and/or tetrafluoroethylene. With some embodiments, the vinyl ether monomer, used to prepare the fluoroethylene vinyl ether polymer segment, includes one or more alkyl vinyl monomers, including, for example, linear or branched C₂-C₈ alkyl vinyl ether, or linear or branched C₂-C₄ alkyl vinyl ether. With some embodiments, in addition to fluoroethylene monomers and alkyl vinyl monomers, the fluoroethylene vinyl ether polymer segment is prepared using one or more optional comonomers, such as: olefins, such as ethylene, propylene, and isobutylene; haloolefins, such as vinyl chloride and vinylidine chloride; unsaturated carboxylic acid esters, such as alkyl (meth)acrylates and vinyl carboxylates, such as vinyl acetate and vinyl butyrate; and hydroxyl functional ethylenically unsaturated monomers, such as hydroxyalkyl vinyl ether monomers.

A non-limiting class of fluorinated polymers from which the fluorinated polymer segments can be prepared or derived, include fluoroethylene-alkyl vinyl ether alternating copolymers (such as those described in U.S. Pat. No. 4,345,057), examples of which include, but are not limited to, LUMIFLON® fluoroethylene copolymers, which are commercially available from AGC Chemicals Americas.

The segmented polymer of the curable photochromic compositions of the present invention, further includes at least one second segment, in which each second segment independently includes at least one of, a polycarbonate segment, a polyester segment, a polyether segment, or a polyurethane segment.

Each polycarbonate segment of each second segment of the segmented polymer can independently be prepared in accordance with art-recognized methods. With some embodiments, and for purposes of non-limiting illustration, each polycarbonate segment can independently be prepared from the reaction of an aliphatic polyol, such as a diol, with a carbonyl dihalide, such as carbonyl dichloride, with removal of the resulting halide acid, such as HCl. For purposes of further non-limiting illustration, each polycarbonate segment can independently be prepared from a transesterification reaction of a polyol, such as a diol, and a dihydrocarbyl carbonate, such as diphenyl carbonate, with removal of the resulting hydroxyl functional hydrocarbyl, such as phenol.

Examples of polyols having at least two hydroxyl groups, from which each polycarbonate segment can be independently prepared, include, but are not limited to glycerin, trimethylolpropane, trimethylolethane, trishydroxyethylisocyanurate, pentaerythritol, ethylene glycol, propylene glycol, trimethylene glycol, 1,3-, 1,2- and 1,4-butanediols, pentane diols (such as, but not limited to, 1,5-pentane diol), heptanediol, hexanediol, octanediol, 4,4′-(propane-2,2-diyl)dicyclohexanol, 4,4′-methylenedicyclohexanol, neopentyl glycol, 2,2,3-trimethylpentane-1,3-diol, 1,4-dimethylolcyclohexane, 2,2,4-trimethylpentane diol, and like polyols.

Each polycarbonate segment of each second segment can independently be free of active hydrogen functionality, or include one or more active hydrogen functional groups each independently selected from hydroxyl, thiol, primary amine, and secondary amine. Active hydrogen functionality can be independently introduced into each polycarbonate segment during formation thereof, or after formation thereof, in accordance with art-recognized methods. With some embodiments, at least some of the polycarbonate segments have hydroxyl functionality. Polycarbonate segments having hydroxyl functionality can, with some embodiments, be prepared from polycarbonate polyols, such as polycarbonate diols. Polycarbonate polyols, such as polycarbonate diols, can, with some further embodiments, be selected from commercially available polycarbonate polyols, such as, but not limited to, ETERNACOLL® polycarbonate diols from UBE Industries, Ltd., and DURANOL polycarbonate diols from Asahi Kasei.

Each polycarbonate segment of each second segment, can have any suitable molecular weight. With some embodiments, each polycarbonate segment of each second segment, independently has an Mw of less than 45,000, such as from 3,000 and 40,000.

Each polyester segment of the second segment of the segmented polymer can independently be prepared in accordance with art-recognized methods. With some embodiments, and for purposes of non-limiting illustration, each polyester segment can be independently prepared by reacting aliphatic carboxylic acid functional materials (and/or cyclic anhydrides thereof, and/or esters thereof) having carboxylic acid functionalities (or effective carboxylic acid functionalities, such as in the case of cyclic anhydrides and carboxylic acid esters) of at least 2, and polyols having hydroxy functionalities of at least 2. The molar equivalents ratio of carboxylic acid groups to hydroxy groups of the reactants is selected such that the resulting polyester segment has hydroxyl functionality and/or carboxylic acid functionality, and a desired molecular weight.

Examples of multifunctional carboxylic acids useful in preparing each polyester segment include, but are not limited to, tetrahydrophthalic acid, hexahydrophthalic acid, endobicyclo-2,2,1,5-heptyne-2,3-dicarboxylic acid, cyclohexanedioic acid, succinic acid, azelaic acid, maleic acid, adipic acid, sebacic acid, and like multifunctional carboxylic acids (optionally including appropriate cyclic anhydrides thereof and/or esters thereof).

Examples of polyols that can be used to prepare each polyester segment of the second segment include, but are not limited to, those polyol examples recited previously herein.

Each polyester segment of each second segment can independently be free of active hydrogen functionality, or include one or more active hydrogen functional groups each independently selected from hydroxyl, thiol, primary amine, and secondary amine. Active hydrogen functionality can be independently introduced into each polyester segment during formation thereof, or after formation thereof, in accordance with art-recognized methods.

Each polyester segment of each second segment, can have any suitable molecular weight. With some embodiments, each polyester segment of each second segment, independently has an Mw of less than 45,000, such as from 3,000 and 40,000.

Each polyether segment of the each second segment of the segmented polymer can independently be prepared in accordance with art-recognized methods. With some embodiments, the polyether segment is selected from polyalkylene glycols, such as, but not limited to, polyethylene glycol, polypropylene glycol, poly(1,2-butylene glycol), polyethylene glycol-polypropylene glycol copolymer, and polytetrahydrofuran.

Each polyether segment of each second segment can independently be free of active hydrogen functionality, or include one or more active hydrogen functional groups each independently selected from hydroxyl, thiol, primary amine, and secondary amine. Active hydrogen functionality can be independently introduced into each polyether segment during formation thereof, or after formation thereof, in accordance with art-recognized methods.

Each polyether segment of each second segment, can have any suitable molecular weight. With some embodiments, each polyether segment of each second segment, independently has an Mw of less than 45,000, such as from 3,000 and 40,000.

Each polyurethane segment of each second segment of the segmented polymer can independently be prepared in accordance with art-recognized methods. With some embodiments, and for purposes of non-limiting illustration, each polyurethane segment can independently be prepared from the reaction of a polyisocyanate having at least two isocyanate groups, with a polyol having at least two hydroxy groups, with: an appropriate molar excess of hydroxyl groups, so as to form a hydroxyl functional polyurethane having at least 2 hydroxyl groups; or an appropriate molar excess of isocyanate groups so as to form a polyurethane having at least 2 isocyanate groups. Examples of polyisocyanates useful in the preparation of polyurethane segments include, with some embodiments, aliphatic, cycloaliphatic and heterocyclic polyisocyanates, and mixtures of such polyisocyanates.

Further examples of polyisocyanates useful in the preparation of polyurethane segments include, but are not limited to, tetramethylene-1,4-diisocyanate; hexamethylene-1,6-diisocyanate; 2,2,4-trimethyl hexane-1,6-diisocyanate; 2,4,4-trimethyl hexane-1,6-diisocyanate; lysine methyl ester diisocyanate; bis(isocyanato ethyl)fumarate; isophorone diisocyanate; ethylene diisocyanate; dodecane-1,12-diisocyanate; cyclobutane-1,3-diisocyanate; cyclohexane-1,3-diisocyanate; cyclohexane-1,4-diisocyanate; methyl cyclohexyl diisocyanate; hexahydrotoluene-2,4-diisocyanate; hexahydrotoluene-2,6-diisocyanate; hexahydrophenylene-1,3-diisocyanate; hexahydrophenylene-1,4-diisocyanate; perhydrodiphenylmethane-2,4′-diisocyanate; perhydrodiphenylmethane-4,4′-diisocyanate; norbornane diisocyanate; and mixtures thereof.

Examples of polyols having at least two hydroxyl groups, from which the polyurethane segments of the second segment can be prepared, include, but are not limited to those polyols recited previously herein.

Each polyurethane segment of each second segment can independently be free of active hydrogen functionality, or include one or more active hydrogen functional groups each independently selected from hydroxyl, thiol, primary amine, and secondary amine. Active hydrogen functionality can be independently introduced into each polyurethane segment during formation thereof, or after formation thereof, in accordance with art-recognized methods.

Each polyurethane segment of each second segment, can have any suitable molecular weight. With some embodiments, each polyurethane segment of each second segment, independently has an Mw of less than 45,000, such as from 3,000 and 40,000.

Each second segment, of the segmented polymers of the curable compositions of the present invention, independently includes, with some embodiments, at least one of a polycarbonate segment, a polycarbonate-polyester segment, a polycarbonate-polyurethane segment, and a polycarbonate-polyester-polyurethane segment.

Each polycarbonate-polyester segment of each second segment of the segmented polymer can independently be prepared in accordance with art-recognized methods. With some embodiments, and for purposes of non-limiting illustration, each polycarbonate-polyester segment can independently be prepared in accordance with the description provided previously herein with regard to the preparation of a polyester segment, in which at least some of the polyols are polycarbonate polyols. The polycarbonate polyols can be prepared in accordance with the description provided previously herein with regard to the preparation of a polycarbonate segment, with the molar ratios of the reactants adjusted such that the resulting polycarbonate has hydroxyl functionality, and correspondingly is a polycarbonate polyol with a desired molecular weight. The polycarbonate polyols, such as polycarbonate diols, from which the polycarbonate-polyester segments are prepared, with some embodiments, has an Mw range of from 500 to 20,000, or from 500, to 10,000, or from 500 to 5,000. Each polycarbonate-polyester segment of each second segment, can have any suitable molecular weight. In accordance with some embodiments, each polycarbonate-polyester segment of each second segment, independently has an Mw of less than 45,000, such from 3,000 to 40,000.

Each polycarbonate-polyurethane segment of each second segment of the segmented polymer can independently be prepared in accordance with art-recognized methods. With some embodiments, and for purposes of non-limiting illustration, each polycarbonate-polyurethane segment can independently be prepared in accordance with the description provided previously herein with regard to the preparation of a polyurethane segment, in which at least some of the polyols are polycarbonate polyols. The polycarbonate polyols can be prepared in accordance with the description provided previously herein with regard to the preparation of a polycarbonate segment, with the molar ratios of the reactants adjusted such that the resulting polycarbonate has hydroxyl functionality, and correspondingly is a polycarbonate polyol having a desired molecular weight. The polycarbonate polyols, such as polycarbonate diols, from which the polycarbonate-polyurethane segments are prepared, with some embodiments, has an Mw range of from 500 to 20,000, or from 500, to 10,000, or from 500 to 5,000. In accordance with some embodiments, each polycarbonate-polyurethane segment of each second segment, independently has an Mw of less than 45,000, such from 3,000 to 40,000.

Each polycarbonate-polyester-polyurethane segment of each second segment of the segmented polymer can independently be prepared in accordance with art-recognized methods. With some embodiments, and for purposes of non-limiting illustration, each polycarbonate-polyester-polyurethane segment can independently be prepared in accordance with the description provided previously herein with regard to the preparation of a polyurethane segment, in which at least some of the polyols are polycarbonate-polyester polyols. The polycarbonate-polyester polyols can be prepared in accordance with the description as provided previously herein, in which the molar ratio of reactants is adjusted such that the resulting polymer has hydroxyl functionality, and correspondingly is a polycarbonate-polyester polyol having a desired molecular weight. The polycarbonate-polyester polyols, such as polycarbonate-polyester diols, from which the polycarbonate-polyester-polyurethane segments are prepared, with some embodiments, has an Mw range of from 1,000 to 20,000, or from 1,000, to 10,000, or from 500 to 5,000. In accordance with some embodiments, each polycarbonate-polyester-polyurethane segment of each second segment, independently has an Mw of less than 45,000, such from 3,000 to 40,000.

With some embodiments, each first segment and each second segment of the segmented polymer are formed separately. Subsequently, the previously formed first segment(s) and the previously formed second segment(s) are combined together (such as reacted together resulting in the formation of covalent bond(s) there-between) so as to form the segmented polymer of the curable photochromic compositions of the present invention. With some additional embodiments, reactive groups, present on the termini of a previously formed second segment(s) may be reacted with complementary reactive groups on a previously formed first segment(s). A non-limiting example of complementary reactive groups include active hydrogens such as hydroxyl, thiol or amine, reacted with isocyanate to form urethane, thiourethane or urea groups, respectively. In the case where the previously formed first and second segments both include active hydrogen groups, a difunctional material including complementary reactive groups, such as isocyanates, may be used to covalently bond the first and second segments. In some embodiments, a portion of the terminal reactive groups on the previously formed second segment(s) may be protected with an art recognized protecting (or blocking) group to prevent gelation, such as a blocked isocyanate.

With some further embodiments, each first segment is initially formed, and subsequently, each second segment is formed by polymerization from (or off of) the backbone of the previously formed first segment(s). A non-limiting example of such a reaction is ring opening polymerization of a cyclic ester to form a polyester second segment directly connected to the first segment.

In accordance with some embodiments, at least a portion of the active hydrogen groups on a separately formed first segment are used to form linkages to second segment(s), thus consuming at least a portion of the active hydrogens of the first segment. In accordance with some further embodiments, substantially all of the active hydrogen groups on a separately formed first segment are used to form linkages to second segment(s), thus consuming substantially all of the active hydrogens of the first segment.

The segmented polymer(s), of the curable photochromic compositions of the present invention, with some embodiments, optionally include active hydrogen groups. Each active hydrogen group of the segmented polymer is, with some embodiments, independently selected from hydroxyl (—OH), thiol (—SH), primary amine (—NH₂), and secondary amine (—NHR′), where each R′ is independently selected from any suitable organic group, such as a linear or branched C₁-C₂₀ alkyl group, and cycloalkyl group, including those classes and examples thereof recited previously herein. With some embodiments, each active hydrogen group, of the segmented polymer, is a hydroxyl group. In accordance with some embodiments, at least one first segment and/or at least one second segment of each segmented polymer independently include one or more active hydrogen groups, such as hydroxyl groups.

With some embodiments, each first segment of the segmented polymer, is free of functional groups, such as hydroxyl, thiol, primary amine, and secondary amine groups.

At least one first segment, of the segmented polymer, includes hydroxyl groups, with some embodiments. Each first segment, of the segmented polymer, includes hydroxyl groups, with some embodiments. With some additional embodiments, at least one first segment, of the segmented polymer, includes hydroxyl groups, and each second segment, of the segmented polymer, is free of hydroxyl groups. In accordance with some further embodiments, each first segment, of the segmented polymer, includes hydroxyl groups, and each second segment, of the segmented polymer, is free of hydroxyl groups.

In accordance with some embodiments of the present invention, the segmented polymer has a hydroxyl number of less than 35, such as less than or equal to 30, or less than or equal to 25, or less than or equal to 20, or less than or equal to 15, or less than or equal to 10.

With the segmented polymers of the curable photochromic compositions of the present invention, and in accordance with some embodiments, at least one first segment and at least one second segment are covalently bonded to each other by a linking group. Examples of such linking groups include, but are not limited to, a carboxylic acid ester linking group (—C(O)O—), a thioester linking group (—C(O)—S—), an amide linking group (—C(O)—N(R^{a})—), a urethane linking group (—N(H)—C(O)—O—), a thiourethane linking group (—N(H)—C(O)—S—), a urea linking group (—N(R^{a})—C(O)—N(R^{a})—), a thiourea linking group (—N(R^{a})—C(S)—N(R^{a})—), a carbonate linking group (—O—C(O)—O—), an ether linking group (—O—), and a thioether linking group (—S—). Each R^{a} group of the above recited linking groups can each be independently selected from hydrogen and any suitable organic group, such as a linear or branched C₁-C₂₀ alkyl group, and cycloalkyl group, including those classes and examples thereof recited previously herein.

With some embodiments of the present invention, each second segment is covalently bonded to at least one first segment. The segmented polymers, of the curable photochromic compositions of the present invention, are free of gelation (are not gelled), with some embodiments.

The segmented polymer, with some embodiments, has a Mw of 35,000 to 250,000, or from 40,000 to 200,000, or from 50,000 to 150,000.

The curable photochromic composition, with some embodiments, includes a catalyst that catalyzes the formation of siloxane linkages. Nonlimiting classes of siloxane catalysts include: acid catalysts, including inorganic or organic acids, such as hydrochloric acid, phosphorous acid, phosphoric acid, phytic acid, nitric acid, acetic acid, oxalic acid, malic acid, maleic acid, citric acid, formic acid, and benzoic acid; base catalysts, including inorganic and organic bases, such as, sodium hydroxide, ammonium hydroxide, ethanolamine, quaternary amines, and tertiary amines, such as dimethylaminoethanol and diazabicyclo[2.2.2]octane; organo-tin compounds, such as dibutyltin dilaurate, and dibutyltin bis(acetylacetonate); and zinc complexes, such as zinc carboxylates. The catalyst is present in the curable photochromic composition, with some embodiments, in an effective amount, such as, but not limited to from 0.05 to 5 percent by weight, based on total weight of the resin solids. A commercially available catalyst is K-KAT® 670 zinc carbonate catalyst.

Without intending to be bound by any theory, it is believed that a cured article, such as a cured film, prepared from the curable photochromic compositions of the present invention, include a 3-dimensional network of siloxane units (—Si—O—Si—) formed from condensation (or self-condensation) of the trialkoxysilane functional material, and further includes domains that are composed substantially of segmented polymer, which further include what is referred to herein as “second segment domains” formed by the second segments of the segmented polymer. It is further believed, without intending to be bound by any theory, that at least some (and in some embodiments, at least a major amount) of the photochromic compounds, of the curable photochromic compositions of the present invention, reside within the second segment domains of the cured article. It is additionally believed, without intending to be bound by any theory, that photochromic compounds residing within the second segment domains have an enhanced range of molecular freedom/motion, which allows the photochromic compounds to more easily and quickly transition between open and closed forms, such as in response to exposure to and removal of a source of actinic radiation, thus resulting in enhanced photochromic performance properties associated with the cured article.

In accordance with some embodiments of the curable photochromic composition of the present invention, the second segment is present in the segmented polymer in an amount of from 50 percent by weight to 90 percent by weight, or from 60 percent by weight to 85 percent by weight, the percent weights based on total weight of the segmented polymer (and being inclusive of the recited values).

The curable photochromic composition, with some embodiments, includes a total amount of second segments of from 10 percent by weight to 45 percent by weight, or from 10 percent by weight to 35 percent by weight, or from 12 percent by weight to 30 percent by weight, the percent by weights in each case being based on total weight of resin solids of the curable photochromic composition (and in each case being inclusive of the recited values).

The segmented polymer is, with some embodiments, present in the curable photochromic composition of the present invention in an amount of from 15 to 50 percent by weight, or from 20 to 50 percent by weight, or from 25 to 40 percent by weight, the percent weights in each case based on total weight of resin solids of the curable photochromic composition.

The curable photochromic compounds of the present invention include a photochromic compound(s). The photochromic compound can be selected from known classes and examples of photochromic compounds, and can include combinations or mixtures thereof.

For example, although not limiting herein, mixtures of photochromic compounds can be used to attain certain activated colors, such as a near neutral gray or near neutral brown. See, for example, U.S. Pat. No. 5,645,767, col. 12, line 66 to col. 13, line 19, which describes the parameters that define neutral gray and brown colors and which disclosure is specifically incorporated by reference herein.

With some embodiments, the photochromic compound, of the curable photochromic compositions of the present invention, is selected from the group consisting of naphthopyrans, benzopyrans, phenanthropyrans, indenonaphthopyrans, spiro(indoline)naphthoxazines, spiro(indoline)pyridobenzoxazines, spiro(benzindoline)pyridobenzoxazines, spiro(benzindoline)naphthoxazines, spiro(indoline)-benzoxazines, fulgides, fulgimides, diarylethenes, and mixtures of such photochromic compounds.

Further examples of other photochromic compounds that can be used in curable photochromic compositions of the present invention include, but are not limited to, those disclosed at column 34, line 20 through column 35, line 13 of U.S. Pat. No. 9,028,728 B2, which disclosure is specifically incorporated by reference herein.

The photochromic compound is present in the curable photochromic composition in an amount at least sufficient so as to provide an article prepared from the composition with a desirable level of photochromic properties, which in some embodiments is referred to as a photochromic amount. With some embodiments, the amount of photochromic compound(s) present in the curable photochromic composition is from 0.001 percent by weight to 40 percent by weight, or from 0.001 to 10 percent by weight, or from 0.01 to 5 percent by weight, or from 0.1 to 2.5 percent by weight, based on the total resin solids weight.

The curable photochromic compositions of the present invention can, with some embodiments, optionally include additives such as, but not limited to: waxes for flow and wetting; flow control agents, such as poly(2-ethylhexyl)acrylate; antioxidants; and ultraviolet (UV) light absorbers. Examples of useful antioxidants and UV light absorbers include, but are not limited to, those available commercially from BASF under the trademarks IRGANOX and TINUVIN. These optional additives, when used, can be present in amounts up to 20 percent by weight, based on total resin solids weight.

The curable photochromic compositions of the present invention can, with some embodiments, further include one or more fixed-tint dyes. As used herein, the term “fixed-tint dye” and related terms, such as “fixed-colorant,” “static colorant,” “fixed dye,” and “static dye” means dyes that are: non-photosensitive materials, which do not physically or chemically respond to electromagnetic radiation with regard to the visually observed color thereof. The term “fixed-tint dye” and related terms as used herein does not include and is distinguishable from photochromic compound. As used herein, the term “non-photosensitive materials” means materials that do not physically or chemically respond to electromagnetic radiation with regard to the visually observed color thereof, including, but not limited to, fixed-tint dyes.

One or more fixed-tint dyes can be present in the curable photochromic compositions of the present invention for purposes including, but not limited to, providing a cured article prepared from the curable photochromic compositions with: at least a base (or first) color characteristic of the fixed-tint dye, when the photochromic compound is not activated; and optionally a second color characteristic of the combination of the fixed-tint dye and the photochromic compound when activated, such as by exposed to actinic radiation.

The optional fixed-tint dye of the curable photochromic composition, with some embodiments, comprises at least one of azo dyes, anthraquinone dyes, xanthene dyes, azime dyes, iodine, iodide salts, polyazo dyes, stilbene dyes, pyrazolone dyes, triphenylmethane dyes, quinoline dyes, oxazine dyes, thiazine dyes, and polyene dyes.

The fixed-tint dye can be present in the curable photochromic composition in varying amounts to provide the intended effect in the cured article prepared therefrom. With some embodiments, the fixed-tint dye is present in the curable photochromic composition in an amount of from 0.001 to 15 percent by weight, or from 0.01 to 10 percent by weight, or from 0.1 to 2.5 percent by weight, the percent weights in each case being based on the total resin solids weight of the curable photochromic composition.

With some embodiments, the curable photochromic composition further includes a water (or moisture) scavenger. A nonlimiting class of water scavengers includes orthoformates, such as trialkyl orthoformates, such as tri(linear or branched C₁-C₆ alkyl) orthoformates. The water scavenger is present in the curable photochromic composition, with some embodiments, in an effective amount, such as from 0.5 to 15 percent by weight, or from 5 to 15 percent by weight, based on total resin solids weight of the curable photochromic composition. A further nonlimiting class of water scavengers includes heterogeneous water scavengers, such as magnesium sulfate and molecular sieves, which are typically separated from the curable photochromic composition, such as by filtration.

The curable photochromic compositions of the present can, with some embodiments, include solvents, selected from water, organic solvents, and combinations thereof.

Classes of organic solvents that can be present in the curable photochromic compositions of the present invention include, but are not limited to: alcohols, such as, methanol, ethanol, n-propanol, iso-propanol, n-butanol, sec-butyl alcohol, tert-butyl alcohol, iso-butyl alcohol, furfuryl alcohol and tetrahydrofurfuryl alcohol; ketones or ketoalcohols, such as, acetone, methyl ethyl ketone, and diacetone alcohol; ethers, such as, dimethyl ether and methyl ethyl ether; cyclic ethers, such as, tetrahydrofuran and dioxane; esters, such as, ethyl acetate, ethyl lactate, ethylene carbonate and propylene carbonate; hydroxy functional ethers of alkylene glycols, such as, butyl-2-hydroxyethyl ether, methy-1,2-hydroxypropyl ether and phenyl-2-hydroxypropyl ether; nitrogen containing cyclic compounds, such as, pyrrolidone, N-methyl-2-pyrrolidone, 1-butyl-pyrrolidinone, and 1,3-dimethyl-2-imidazolidinone; sulfur containing compounds, such as, dimethyl sulfoxide and tetramethylene sulfone; aromatic compounds, such as, toluene, xylene, anisole, and butyl benzoate; and mixtures of aromatic compounds, such as, but not limited to, Aromatic 100 Fluid, which is a commercially available mixture of C₉-C₁₀ dialkyl- and trialkyl-benzenes, and Aromatic 150 Fluid, which is a commercially available mixture of C₁₀-C₁₂ alkylbenzenes and alkylnaphthalenes.

Solvent(s) can be present in the curable photochromic compositions of the present invention, in an amount of from 5 to 95 percent by weight, or from 15 to 80 percent by weight, from 30 to 70 percent by weight, or from 30 to 60 percent by weight, in each case based on the total weight of the curable photochromic composition (including the weight of the solvent).

The present invention also relates to articles, and in particular, photochromic articles that are prepared from the curable photochromic composition of the present invention as described previously herein. With some embodiments, the photochromic article is selected from layers (including films and/or sheets), and 3-dimensional articles.

Classes of 3-dimensional articles, that can be prepared from the curable photochromic compositions of the present invention, include, but are not limited to, ophthalmic articles, display articles, windows, and mirrors.

More typically, the curable photochromic compositions of the present invention are used to prepare photochromic layers, such as photochromic films and photochromic sheets. As used herein, the term “film” means a layer that is not self-supporting, such as, but not limited to, a coating. As used herein, the term “sheet” means a layer that is self-supporting.

The curable photochromic composition of the present invention can be cured by any suitable methods that result in the condensation (or self-condensation) of alkoxysilane groups of the trialkoxysilane functional material. With some further embodiments, the curable photochromic composition is cured at ambient conditions, such as at room temperature of about 25° C. for up to one week. With some further embodiments, the curable photochromic composition is cured by exposure to elevated temperature (in excess of ambient room temperature). As used herein, by “cured” is meant a three dimensional crosslink network is formed by covalent bond formation, such as siloxane linkages or units (—Si—O—Si—) resulting from condensation (or self-condensation) of or between alkoxysilane groups of the trialkoxysilane functional material. When cured at elevated temperature, the curable photochromic composition can be referred to herein as a thermosetting curable photochromic composition. The temperature at which the thermosetting curable photochromic composition of the present invention is cured is variable and depends in part on the amount of time during which curing is conducted. With some embodiments, the curable photochromic composition is cured at an elevated temperature of from 35° C. to 175° C., or from 40° C. to 150° C., or from 80° C. to 130° C., for a period of 15 to 240 minutes.

The present invention also relates to an article, such as a photochromic article, that comprises: (A) a substrate; and (B) a photochromic layer over at least one surface of the substrate, wherein the photochromic layer is formed from the curable photochromic composition of the present invention.

The article, that includes a substrate, and a photochromic layer over at least one surface of the substrate (formed from the curable photochromic composition of the present invention) can, with some embodiments, be selected from ophthalmic articles, display articles, windows, and mirrors. Correspondingly, the substrate of the article can be selected from ophthalmic substrates, displays, windows, and mirrors. The substrate can be composed of one or more suitable materials, including, but not limited to: organic materials, such as organic polymeric materials, such as, but not limited to, thermoplastic polycarbonates, crosslinked polycarbonates, poly(meth)acrylates, and combinations thereof; glasses, such as silica-based glasses; metals; ceramic materials; and combinations thereof. Examples of substrates that can be included in the article (including optical elements) of the present invention include, but are not limited to, those described at column 35, line 5 through column 36, line 57 of U.S. Pat. No. 8,628,685 B2, which disclosure is incorporated herein by reference.

The substrate, with some embodiments, can optionally include a photochromic material and/or a fixed-tint dye, which can each be selected from those classes and examples of photochromic materials and fixed-tint dyes as described previously herein. The optional photochromic material(s)/compound(s) present in the substrate can be the same or different than the photochromic compound(s) of the photochromic layer. The optional fixed-tint dye(s) can be the same or different than the optional fixed-tint dye(s) of the photochromic layer.

The photochromic layer of the article can be a photochromic film or a photochromic sheet. With some embodiments, the photochromic film of the article is a photochromic coating, and the curable photochromic composition of the present invention is a curable photochromic coating composition.

The curable photochromic coating composition can be applied to the substrate in accordance with art-recognized methods, which include, but are not limited to, spray application methods, curtain coating application methods, draw-down blade (or bar) application methods, dip-coating application methods, spin-coating application methods, jet printing methods (such as inkjet printing methods, where the “ink” is replaced with a curable photochromic composition according to the present invention), and combinations thereof.

After application of the curable photochromic composition over at least one surface of the substrate, the applied curable photochromic composition is cured, such as described previously herein. The photochromic layer can be in the form of a single layer or multiple layers. When in the form of multiple layers, each layer of the photochromic layer can be prepared from curable photochromic compositions according to the present invention, having the same or different compositions, such as the same or different photochromic compound(s). The photochromic layer can have any suitable thickness, such as from 10 micrometers to 250 micrometers, or from 15 micrometers to 75 micrometers.

In addition to the photochromic layer, the article can optionally include one or more further art-recognized layers, such as, but not limited to: a primer layer(s); an adhesive layer(s); a protective layer(s) (such as a hard-coat layer); a polarizing layer(s); a birefringent layer(s); an antireflective layer(s); and/or another photochromic layer(s) that is prepared from a composition other than the curable photochromic composition of the present invention.

The present invention further relates to a photochromic multilayer article including at least one photochromic layer formed from the curable photochromic composition of the present invention. Each layer of the photochromic multilayer article can independently be in the form of a film or a sheet. The photochromic multilayer article can include, with some embodiments, two or more layers that are formed from the same or different curable photochromic compositions of the present invention.

The multilayer article of the present invention can optionally include one or more further art-recognized layers, such as, but not limited to: an adhesive layer(s); a protective layer(s) (such as a hard-coat layer); a polarizing layer(s); a birefringent layer(s); an antireflective layer(s); and/or another photochromic layer(s) that is prepared from a composition other than the curable photochromic composition of the present invention.

The multilayer article of the present invention can have any suitable thickness, such as from 10 micrometers to 1000 micrometers, or from 15 micrometers to 750 micrometers, or from 25 to 100 micrometers.

The multilayer article of the present invention can be used alone or in conjunction with another article, such as a substrate. The substrate can be selected from those classes and examples of substrates as described previously herein with regard to the article of the present invention, such as ophthalmic substrates, displays, windows, and/or mirrors. The substrate can be composed of one or more suitable materials, including, but not limited to: organic materials, such as organic polymeric materials; glasses, such as silica-based glasses; metals; ceramic materials; and combinations thereof.

The multilayer article of the present invention can be adhered to a surface of a substrate by art-recognized methods, such as, but not limited to: static clinging, such as with static electricity; one or more interposed adhesive layers; fusion bonding, such as thermal fusion bonding; and in-mold formation, such as where the multilayer article is placed in a mold, and the substrate is formed against at least one surface of the multilayer article within the mold. The multilayer article of the present invention can, with some embodiments, be supported by one or more brackets that engage retainingly with one or more peripheral regions of the multilayer article.

The present invention can be further characterized by one or more of the following non-limiting clauses.

Clause 1: A curable photochromic composition comprising:
(a) a photochromic compound;
(b) a trialkoxysilane functional material having at least two trialkoxysilane groups; and
(c) a segmented polymer comprising, at least one first segment, and at least one second segment, wherein,
   (i) each first segment independently comprises at least one of a (meth)acrylic polymer segment, or a fluoroethylene vinyl ether polymer segment, and
   (ii) each second segment independently comprises at least one of, a polycarbonate segment, a polyester segment, a polyether segment, or a polyurethane segment.

Clause 2: The curable photochromic composition of clause 1, wherein the first segment comprises hydroxyl groups.

Clause 3: The curable photochromic composition of clause 1 or clause 2, wherein the segmented polymer has a hydroxyl number of less than 35.

Clause 4: The curable photochromic composition of any one of clauses 1-3, wherein the second segment is present in the segmented polymer in an amount of from 50 percent by weight to 90 percent by weight, based on total weight of the segmented polymer.

Clause 5: The curable photochromic composition of any one of clauses 1-4, wherein the segmented polymer has a Mw of 35,000 to 250,000.

Clause 6: The curable photochromic composition of any one of clauses 1-5, wherein each second segment independently comprises, the polycarbonate segment, a polycarbonate-polyester segment, a polycarbonate-polyurethane segment, and a polycarbonate-polyester-polyurethane segment.

Clause 7: The curable photochromic composition of any one of clauses 1-6, wherein the trialkoxysilane functional material includes one or more of the following linkages: ether linkages (—O—); thioether linkages (—S—); urea linkages (—N(R)—C(O)—N(R)—); carbonate linkages (—O—C(O)—O—); carboxylic acid ester linkages (—O—C(O)—); urethane linkages (—N(H)—C(O)—O—); thiourethane linkages (—S—C(O)—N(H)—); thiourea linkages (—N(R)—C(S)—N(R)—); and amide linkages (—C(O)N(R)—), wherein each R is in each case independently selected from hydrogen, alkyl, haloalkyl, perhaloalkyl, cycloalkyl, heterocycloalkyl, and combinations thereof.

Clause 8: The curable photochromic composition of any one of clauses 1-7, wherein the trialkoxysilane functional material is represented by the following Formula (I),

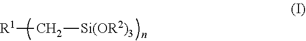

wherein n is at least 2,
each R² is independently methyl or ethyl, and
R¹ comprises at least one of,
   a polyvalent aliphatic hydrocarbon residue,
   a polyvalent aliphatic ether residue,
   a polyvalent aliphatic urethane residue,
   a polyvalent aliphatic carboxylic acid ester residue, or
   a polyvalent aliphatic carbonate residue.

Clause 9: The curable photochromic composition of clause 8, wherein n of Formula (I) is from 2 to 20, or from 2 to 15, or from 2 to 10, or from 2 to 8, or from 2 to 6, or from 2 to 5, or from 2 to 4, or from 2 to 3.

Clause 10: The curable photochromic composition of clause 8 or clause 9, wherein R¹ comprises at least one of polyvalent aliphatic hydrocarbon residue, polyvalent aliphatic urethane residue, or polyvalent aliphatic carbonate residue.

Clause 11: The curable photochromic composition of any one of clauses 8-10, wherein the trialkoxysilane functional material comprises Si in an amount of from 5.0 to 16.0 percent by weight, based on solids weight of the trialkoxysilane functional material.

Clause 12: The curable photochromic composition of any one of clauses 1-11, wherein a weight ratio of the trialkoxysilane functional material to the segmented polymer is from 80:20 to 50:50.

Clause 13: The curable photochromic composition of any one of clauses 1-12, wherein the weight ratio of the trialkoxysilane functional material to the segmented polymer is from 70:30 to 60:40, or from 75:25 to 60:40.

Clause 14: The curable photochromic composition of any one of clauses 1-13, wherein the curable photochromic composition comprises a total amount of second segments of from 10 percent by weight to 45 percent by weight, based on total solids weight of the curable photochromic composition.

Clause 15: The curable photochromic composition of any one of clauses 1-14, wherein the curable photochromic composition further comprises a water scavenger.

Clause 16: The curable photochromic composition of clause 15, wherein the water scavenger comprises one or more trialkyl orthoformates.

Clause 17: The curable photochromic composition of any one of clauses 1-16, wherein the curable photochromic composition further comprises a catalyst that catalyzes the formation of siloxane linkages.

Clause 18: The curable photochromic composition of any one of clauses 1-17, wherein the photochromic compound comprises at least one of naphthopyrans, benzopyrans, phenanthropyrans, indenonaphthopyrans, spiro(indoline)naphthoxazines, spiro(indoline)pyridobenzoxazines, spiro(benzindoline)pyridobenzoxazines, spiro(benzindoline)naphthoxazines, spiro(indoline)-benzoxazines, fulgides, fulgimides, or mixtures of such photochromic compounds.

Clause 19: An article comprising:
(A) a substrate; and
(B) a photochromic layer over at least one surface of the substrate, wherein the photochromic layer is formed from the curable photochromic composition of any one of clauses 1-18.

The present invention is more particularly described in the following examples, which are intended to be illustrative only, since numerous modifications and variations therein will be apparent to those skilled in the art. Unless otherwise specified, all parts and all percentages are by weight.

### EXAMPLES

Certain values and terms, relating to physical properties, as used in the following examples, were determined in accordance with the following descriptions, unless otherwise stated.

Acid values were determined in accordance with the method of ASTM D1639. Results are reported in units of mg KOH/g.

Hydroxyl values (OH values) are typically determined in accordance with art-recognized methods. As reported in the following examples, each hydroxyl value is the mg of KOH equivalents to the hydroxyl groups in 1 g of the material of interest. In accordance with art-recognized methods, a known mass of sample of interest is weighed accurately into a flask and dissolved in 20 mL tetrahydrofuran. Ten milliliters (10 mL) of 0.1 molarity (0.1 M) 4-(dimethylamino)pyridine in tetrahydrofuran and 5 mL of a 9 vol % solution of acetic anhydride in tetrahydrofuran are then added to the mixture. After 5 minutes, 10 mL of an 80 vol % tetrahydrofuran/water solution is added. After 15 minutes, 10 mL tetrahydrofuran is added and the solution is titrated with 0.5 M ethanolic potassium hydroxide (KOH). A blank sample is also run where the sample of interest is omitted. The resulting hydroxyl number is expressed in units of mg KOH/g and is calculated in accordance with the following equation (Eq. A):

$$Hydroxyl value = \frac{( V 2 - V 1 ) \times molarity of KOH solution ( M ) \times 56. 1}{mass of sample ( g )} \qquad Eq . A$$

With reference to Eq. A: V2 is the amount (mL) of KOH solution required to titrate the blank; V1 is the amount (mL) of KOH solution required to titrate the acetylated sample; 56.1 is the formula weight of KOH; “mass of sample” is the mass of the sample of interest (in grams). Unless otherwise indicated, OH values as recited in the following examples were determined in accordance with the above-described method, and were not corrected for solids.

Theoretical hydroxyl values, for all segmented polymer examples, were calculated in accordance with the following equation (Eq. B):

$$Theoretical OH value = \frac{56100 \times [ theoretical OH equivalents ]}{total mas s of solids ( g )} \qquad Eq . B$$

With reference to Eq. B, “theoretical OH equivalents” is the amount of theoretical hydroxyl equivalents remaining when all equivalents of isocyanate have been reacted, and is calculated by subtracting the known equivalents of hydroxyl functionality from the total equivalents of isocyanate functionality. The equivalents of hydroxyl functionality introduced into the reaction is the sum of the first segment, second segment, and additional octanol and/or butanol for each. To determine whether and when all equivalents of isocyanate have been reacted, a drop of reaction solution is placed onto a colorimetric SWYPE™ pad for aliphatic isocyanates, commercially available from SKC, Inc. The absence of color change (of the SWYPE™ pad) indicates that isocyanate is undetectable, and correspondingly all equivalents of isocyanate have been reacted (or otherwise consumed).

In Part 1 of the following examples, there is described the preparation of second segments that can be used to prepare segmented polymers according to the present invention. In Part 2 there is described the preparation of segmented polymers according to the present invention. In Part 3 there is described the preparation of trialkoxysilane functional materials according to the present invention. In Part 4 there is described the preparation of comparative curable photochromic compositions, and curable photochromic compositions according to the present invention. In Part 5 there is described the preparation of test specimens. In Part 6 there is described test methods and test results obtained from the test specimens of Part 5.

### Part 1: Preparation of Second Segments.

The charges and ingredients used in preparing of the second segments are summarized in the following Table 1. With reference to Table 1, and for each example, Charge 1 was introduced into a reactor equipped with mechanical stirring, a Dean Stark trap, a nitrogen blanket (or sweep), and a thermocouple-controlled heating mantle. The contents of the reactor were heated to 170° C. to achieve a strong reflux. Xylenes and water were removed from the Dean Stark trap as needed to maintain a strong reflux between 170° C. to 180° C. The reaction was held at reflux until the measured acid value was less than 1 mg KOH/g, at which time Charge 2 was added in the case of SS-A. When the acid value again was determined to be less than 1 mg KOH/g, Charge 3 was added in the case of SS-A. For each example other than SS-A, once the acid value dropped below 1 mg KOH/g, the solution was cooled to 130° C., and Charge 4 was added. For example SS-A, the solution was cooled to 130° C., and Charge 4 was added three hours after the addition of charge 3. After completion of each reaction, the contents of the reactor, including the product second segment, were removed and stored without work-up or other modification. The resulting product mixtures, including the product second segment, were found to have the properties listed in Table 1.

TABLE 1

| | | Parts by Weight | | | | | |
|---|---|---|---|---|---|---|---|
| Charge | Ingredients | SS-A | SS-B | SS-C | SS-D | SS-E | SS-F |
| 1 | DURANOL ™ | 80.1 | 321.3 | 80.1 | 1737.7 | | 1715.9 |
| | T5652¹ | | | | | | |
| | ETERNACOLL ® | | | | | 1756 | |
| | PH-200D² | | | | | | |
| | Adipic acid | 4.7 | 18.3 | 4.7 | 98 | 102.5 | 97.65 |
| | Triphenyl phosphite | 0.17 | 0.67 | 0.17 | 3.62 | 3.67 | 3.58 |
| | Monobutyltin | 0.08 | 0.33 | 0.08 | 1.81 | 1.83 | 1.79 |
| | hydroxide oxide | | | | | | |
| | Aromatic 150 | 3.6 | 13.4 | 4 | 72.46 | 233.8 | 71.6 |
| | Xylenes | 11.8 | 48.8 | 11.8 | 263.6 | 366.7 | 260.4 |
| 2 | Adipic acid | 1.17 | | | | | |
| 3 | Adipic acid | 0.23 | | | | | |
| 4 | Aromatic 150 | 56 | 273 | 68 | 1473 | 1233 | 1450 |
| Product | Percent Solids³ | 51.1 | 48.54 | 50.6 | 50.34 | 51.25 | 50.7 |
| | Weight average | 35300 | 26300 | 18200 | 26200 | 22600 | 28300 |
| | Molecular weight | | | | | | |
| | (Mw) | | | | | | |
| | Polydispersity | 1.98 | 2.21 | 2.13 | 2.52 | 2.15 | 1.91 |
| | Index (PDI) | | | | | | |
| | OH Value | 4.54 | 8.23 | 11.44 | 14.04⁴ | 8.96 | 8.36 |

¹A polycarbonate diol from Asahi Kasei, with an average OH value of 56 mg KOH/g.
²A polycarbonate diol from Ube Corporation, with reported OH value of 56 mg KOH/g
³% solids measured after 1.5 hours in an 120° C. oven
⁴OH value for this sample was calculated based on NMR and is based on solids.

### Part 2: Preparation of Segmented Polymers.

### Part 2a: Preparation of Segmented Polymers Having Fluoroethylene Vinyl Ether First Segments.

The charges and ingredients used in preparing of the segmented polymers with fluoroethylene vinyl ether first segments are summarized in the following Table 2. With reference to Table 2, and for each example, Charge 1 was added to a reactor with mechanical stirring, a thermocouple-controlled heating mantle, and a nitrogen blanket (or sweep). The contents of the reactor were in each case heated to the First Temperature and held for the First Hold Time, as indicated in Table 2. Charge 2 was added followed by Charge 3 (where indicated). The reaction mixture was adjusted to the Second Temperature, and held for the Second Hold Time, as indicated in Table 2. Charge 4 was added and the reaction continued until isocyanate was no longer detected. After completion of each reaction, the contents of the reactor, including the product segmented polymer, were removed and stored without work-up or other modification. The resulting product mixtures, including the product segmented polymer, were found to have the properties listed in Table 2.

TABLE 2

| | | Parts by weight | | | | | |
|---|---|---|---|---|---|---|---|
| Charge | Ingredients/Example | SP-1 | SP-2 | SP-3 | SP-4 | SP-5 | SP-6 |
| 1 | Example SS-C | | 120.66 | | | | |
| | Example SS-B | 237.20 | | 104.63 | | | |
| | Example SS-E | | | | 138.44 | | |
| | Example SS-F | | | | | 487.4 | |
| | Example SS-A | | | | | | 103.52 |
| | VESTANAT ® TMDI⁵ | 6.06 | 5.13 | 2.38 | 4.59 | 13.83 | 1.64 |
| | Dibutyltindilaurate | 0.16 | 0.11 | | 0.09 | 0.33 | 0.06 |
| | Aromatic 150 | 105.6 | 87.6 | 43 | 89 | 280 | 49 |
| First Temperature (° C.) | | 80° C. | 75° C. | 80° C. | 80° C. | 80° C. | 80° C. |
| First Hold Time (minutes) | | 150 | 120 | 120 | 150 | 120 | 120 |
| 2 | Aromatic 150 | 6.2 | 5 | 9 | 9 | 28.5 | 9.5 |
| | 1-octanol | 1.877 | 9.370 | 0.736 | | | 0.5094 |
| | 1-butanol | | | | 0.810 | 2.44 | |
| 3 | Dibutyltindilaurate | — | — | — | — | — | 0.06 |
| Second Temperature (° C.) | | 85° C. | 75° C. | 80° C. | 70° C. | 60° C. | 80° C. |
| Second Hold Time (minutes) | | 60 | 30 | 30 | 10 | 40 | 60 |
| 4 | LUMIFLON ® | 32.34 | | 6.03 | | | 8.69 |
| | LF916F⁶ | | | | | | |
| | LUMIFLON ® LF910 | | 60.44⁷ | | 26.7⁸ | 96.97⁷ | |
| | Aromatic 150 | 52.6 | 14.0 | 30.7 | | 46 | 10.4 |
| Product | % Solids | 34.72 | 36.34 | 32.48 | 35.25 | 35.45 | 35.9 |
| | Weight average | 94,200 | 49,300 | 205,000 | 37,400 | 69,400 | 131,000 |
| | Molecular weight | | | | | | |
| | (Mw) | | | | | | |
| | Theoretical OH value | 17.8 | 31.9 | 6.5 | 12.9 | 15.5 | 10.7 |
| | (100% solids) | | | | | | |

⁵A mixture of 2,2,4- and 2,4,4-trimethyl-hexamethylene diisocyanate available from Evonik Industries.
⁶A fluoroethylene vinyl ether polyol available from Asahi Glass, with an OH value of 101 and a percent solids of 99%.
⁷A fluoroethylene vinyl ether polyol available from Asahi Glass, with a measured OH value of 68 (based on solids) and a percent solids of 65.9%.
⁸A fluoroethylene vinyl ether polyol available from Asahi Glass, with a measured OH value of 68 (based on solids) and a % solids of 66.2%.

### Part 2B: Preparation of a Segmented Polymer Having an Acrylic First Segment.

The charges and ingredients used in preparing of the segmented polymer (SP-7) having an acrylic first segment are summarized in the following Table 3. With reference to Table 3, Charge 1 was added to a reactor with mechanical stirring, a thermocouple-controlled heating mantle, and a nitrogen blanket (or sweep). The contents of the reactor were heated to 80° C. for 120 minutes. Charge 2 was added. After 30 minutes, Charges 3 and 4 were added and the contents of the reactor were held at 80° C. for 5 hours. Charge 5 was added to quench any remaining isocyanate. After completion of the reaction, the contents of the reactor, including the product segmented polymer, were removed and stored without work-up or other modification. The resulting product mixture, including the product segmented polymer, was found to have the properties listed in Table 3.

TABLE 3
Segmented Polymer SP-7

| | | Parts by |
|---|---|---|
| Charge | Ingredients | Weight |
| 1 | Example SS-D | 647.15 |
| | VESTANAT ® TMDI | 17.11 |
| | Dibutyltindilaurate | 0.39 |
| | Aromatic 150 | 267 |
| 2 | Aromatic 150 | 38 |
| | 1-butanol | 3.018 |
| 3 | (Meth)acrylic polyol⁹ | 71.512 |
| 4 | Aromatic 150 | 49 |
| 5 | 1-propanol | 4 |
| Product | % Solids | 36.18 |
| | Weight average Molecular weight | 109,000 |
| | (Mw) | |
| | Theoretical OH value (100% | 11.7 |
| | solids) | |

⁹Prepared by free radical polymerization of hydroxypropyl methacrylate (40.4%), butyl methacrylate (57.6%), and acrylic acid (2.0%), and had: a total solids of 61.5% by weight; a weight average molecular weight (Mw) of 5500; a polydispersity index of 1.96; and a theoretical hydroxyl equivalent weight (on solids) of 360.

### Part 3: Preparation of Trialkoxysilane Materials.

Four different trialkoxysilane materials (Examples A through D) were prepared in accordance with the following descriptions.

### Example A

Trimethylolpropane (96.88 g), 3-Isocyanatopropyltrimethoxysilane (444.67 g), and anisol (125.5 g) were combined in a 1 L 4-Neck round bottom flask fitted with mechanical stirrer and condenser under nitrogen. The contents of the flask were heated to 70° C. over 2 hours with continuous stirring. After one hour at 70° C., the contents of the flask were cooled to room temperature, and 0.05 g K-KAT 348 (a bismuth carboxylate catalyst available from King Industries) was added. The contents of the flask were heated to 70° C. over a period of one hour, then held until isocyanate was undetectable (approximately 6 hours). The contents of the flask, including the product trialkoxysilane functional material were removed, without work-up or other modification, and stored under nitrogen at 79.4% total solids. The product trialkoxysilane functional material was calculated to have a molecular weight of 750 g/mole, and 11.23% Si by weight based on solids. The following Formula (Ex-A) is a representative structural formula of the product trialkoxysilane functional material of Example A.

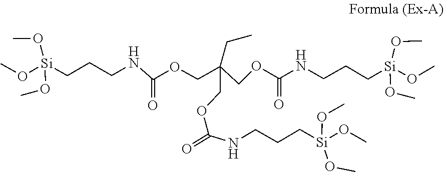

### Example B

Pentaerythritol (15.87 g), 3-Isocyanatopropyltrimethoxysilane (95.72 g), K-KAT® 348 (0.01 g, a bismuth carboxylate catalyst available from King Industries), and tetrahydrofuran (40.0 g) were combined in a 250 mL 3-Neck round bottom flask with mechanical stirrer and condenser under nitrogen sweep. The mixture was stirred and heated to 70° C. over 30 minutes, then held at 70° C. until isocyanate was undetectable (5 hours). The contents of the flask, including the product trialkoxysilane functional material, were cooled to room temperature, removed from the flask without work-up or other modification, and stored under nitrogen in a glass jar at 78.9% total solids. The resulting product trialkoxysilane functional material was calculated to have a molecular weight of 957.3 g/mole, and 11.7% silicon by weight based on solids. The following Formula (Ex-B) is a representative structural formula of the product trialkoxysilane functional material of Example B.

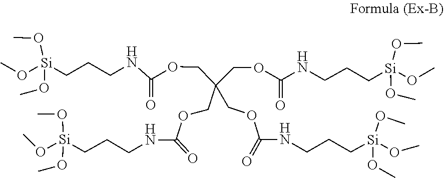

### Example C

DESMODUR® N 3200 (40.37 g, hexamethylene diisocyanate biuret, commercially available from Covestro), (3-mercaptopropyl)trimethoxysilane (45.48 g), and triethylamine (0.086 g) were combined in a glass jar with a magnetic stir bar. The contents of the glass jar were stirred at room temperature for two hours, at which point isocyanate was undetectable. The contents of the glass jar were kept therein without work-up or other modification, and stored under nitrogen. The resulting product trialkoxysilane functional material had a calculated molecular weight of 1067.6 g/mole, and 7.89% Silicon by weight based on solids. The following Formula (Ex-C) is a representative structural formula of the product trialkoxysilane functional material of Example C.

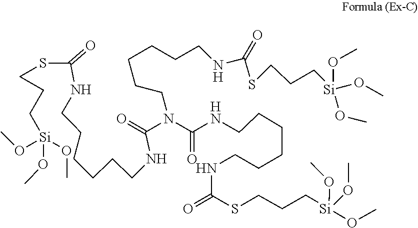

### Example D

Neopentyl glycol diacrylate (21.89 g), and (3-aminopropyl)trimethoxysilane (36.98 g) were combined in a 100 mL 3-Neck round bottom flask with magnetic stir and condenser. The contents of the flask were stirred at room temperature for 30 minutes, followed by addition of dibutyltin dilaurate (0.06 g). The contents of the flask were then heated to 80° C. over a period of 1.5 hours under nitrogen. After the reaction was held at 80° C. for 6 hours, less than 0.1% by weight of neopentyl glycol diacrylate was detected by GC (gas chromatography). The contents of the flask were cooled to room temperature, removed from the flask, and stored under nitrogen without work-up or other modification. The resulting product trialkoxysilane functional material was calculated to have a molecular weight of 570.8 g/mole, and 9.84% Silicon by weight. The following Formula (Ex-D) is a representative structural formula of the product trialkoxysilane functional material of Example D.

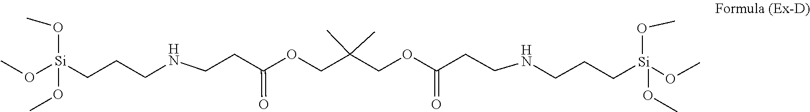

### Part 4: Preparation of Curable Photochromic Compositions.

In this Part 4, there is described the preparation of comparative curable photochromic compositions (CE-1 and CE-2), and curable photochromic compositions according to the present invention (Examples 3 through 8).

### Comparative Example CE-1

The curable photochromic composition of Comparative Example CE-1 includes second segment SS-B (a polycarbonate polyester second segment) in the absence of (or in place of) a segmented polymer. The charges and ingredients used in preparing the curable photochromic composition of Comparative Example CE-1 are summarized in the following Table 4.

With reference to Table 4, the ingredients of Charge 1 were combined and mixed in a suitable container at 40° C. to 60° C. until the contents of the container were observed to be homogeneous. The polycarbonate-polyester second segment SS-B of Charge 2 was added and the resulting contents of the container were mixed for at least 30 minutes while heating to 40° C. The ingredients of Charge 3 were added to the container, and the contents of the container were mixed for an additional 30 minutes. Finally, the catalyst of Charge 4 was added to the container, and the resulting contents were mixed for 30 minutes. The container, with the curable photochromic composition of Comparative Example CE-1 therein, was then placed on a benchtop roller-mixer overnight.

TABLE 4

| Charge | Ingredients | Parts by Weight |
|---|---|---|
| 1 | Photochromic Blend¹⁰ | 9.0 |
| | Anisole | 21.0 |
| 2 | Polycarbonate Polyester | 53.5 |
| | Segment SS-B | |
| 3 | Alkoxysilane of Example A | 93.2 |
| | γ-glycidoxypropyl- | 2.0 |
| | trimethoxysilane | |
| | Triethyl orthoformate | 9.6 |
| 4 | K-KAT ® 670¹¹ | 4.0 |

¹⁰A blend of 5 parts photochromic indenofused naphthopyran dyes selected to provide a green-gray color on activation, 2 parts hindered amine light stabilizer and 2 parts hindered phenolic antioxidant.
¹¹A zinc complex catalyst from King Industries.

### Comparative Example CE-2

The curable photochromic composition of Comparative Example CE-2 includes a polyisocyante in the absence of (or in place of) a trialkoxysilane functional material. The segmented polymer (SP-1), of Comparative Example CE-2, was prepared using and includes the polycarbonate polyester second segment SS-B used in Comparative Example CE-1.

The charges and ingredients used in preparing the curable photochromic composition of Comparative Example CE-2 are summarized in the following Table 5. With reference to Table 5, the ingredients of Charge 1 were combined and mixed in a suitable container at 40° C. to 60° C. until the contents of the container were observed to be homogeneous. The segmented polymer SP-1 of Charge 2 was added to the container, and the contents thereof were mixed for at least 30 minutes while heating to 40° C. The ingredients of Charge 3 were added, and the contents of the container were mixed for an additional 30 minutes. The container, with the curable photochromic composition of Comparative Example CE-2 therein, was then placed on a benchtop roller-mixer overnight.

TABLE 5

| | | Comparative |
|---|---|---|
| | | Example |
| Charge | Parts By Weight | CE-2 |
| 1 | Photochromic Blend¹⁰ | 9.0 |
| | Tamisolve ™ NxG¹² | 35.9 |
| | Aromatic 150 | 24.0 |
| | Propylene Carbonate | 11.8 |
| 2 | Segmented polymer Example SP-1 | 109.0 |
| 3 | TRIXENE ® BI-7960¹³ | 88.8 |
| | γ-glycidoxypropyl-trimethoxysilane | 4.5 |
| | BYK ® 333¹⁴ | 0.1 |
| | K-KAT ® 348¹⁵ | 0.7 |

¹⁰A blend of 5 parts photochromic indenofused naphthopyran dyes selected to provide a green-gray color on activation, 2 parts hindered amine light stabilizer and 2 parts hindered phenolic antioxidant.
¹²A dipolar aprotic solvent available from Eastman.
¹³Hexamethylene diisocyanate biuret blocked with 3,5-dimethylpyrazole, available from Baxenden Chemical Co.
¹⁴A polyether modified polydimethylsiloxane from BYK-Chemie, USA.
¹⁵A bismuth carboxylate catalyst from King Industries.

### Curable Photochromic Composition Examples (3-11) According to the Present Invention

The charges and ingredients used in preparing of the curable photochromic compositions according to the present invention are summarized in the following Table 6 and Table 7. With the curable photochromic compositions according to the present invention of Examples 3-8 (Table 6), the same trialkoxysilane functional material (of Example A) was used. With the curable photochromic compositions according to the present invention of Examples 9-11 (Table 7), different trialkoxysilane functional materials (Examples B, C, and D) were used. A summary of various formulation details (e.g., weight ratio of alkoxysilane to segmented polymer) of the inventive curable photochromic compositions of Examples 3-11 is provided in Table 8.

For each of Examples 3-8 of Table 6, and each of Example 9-11 of Table 7, the ingredients of Charge 1 were combined and mixed in a suitable container at 40° C. to 60° C. until the contents of the container were observed to be homogeneous. Charge 2 was then added to each container (as indicated) and the contents of each container were mixed at 40° C. for at least 30 minutes. The ingredients of Charge 3 were then added and the resulting contents mixed for a minimum of 30 minutes. Finally, Charge 4 was added to each container and the contents mixed for a minimum of 30 minutes. Each container, with the curable photochromic compositions of Examples 3-11 therein, was then placed on a benchtop roller-mixer overnight.

TABLE 6

| | | Parts by weight | | | | | |
|---|---|---|---|---|---|---|---|
| | | Exam- | Exam- | Exam- | Exam- | Exam- | Exam- |
| Charge | Ingredient | ple 3 | ple 4 | ple 5 | ple 6 | ple 7 | ple 8 |
| 1 | Photochromic | 9.0 | 9.1 | 9.0 | 9.0 | 9.0 | 9.0 |
| | Blend¹⁰ | | | | | | |
| | Anisole | 35.4 | 35.6 | 61.5 | 23.0 | 35.6 | 23.1 |
| 2 | Example SP-1 | 100.8 | 57.6 | | | | |
| | Example SP-2 | | | | | 125.9 | |
| | Example SP-3 | | | 107.6 | | | |
| | Example SP-4 | | | | 99.1 | | |
| | Example SP-7 | | | | | | 96.7 |
| 3 | Alkoxysilane of | 81.9 | 100.8 | 81.9 | 81.2 | 68.3 | 81.1 |
| | Example A | | | | | | |
| | γ- | 2.0 | 2.0 | 2.1 | 2.8 | 2.0 | 2.0 |
| | glycidoxypropyl- | | | | | | |
| | trimethoxysilane | | | | | | |
| | Triethyl | 12.3 | 11.1 | 14.0 | 11.3 | 12.8 | 11.3 |
| | orthoformate | | | | | | |
| 4 | K-KAT 670¹¹ | 4.0 | 4.0 | 4.0 | 4.2 | 4.0 | 4.0 |

¹⁰A blend of 5 parts photochromic indenofused naphthopyran dyes selected to provide a green-gray color on activation, 2 parts hindered amine light stabilizer and 2 parts hindered phenolic antioxidant.
¹¹A zinc complex catalyst from King Industries.

TABLE 7

Parts by weight

| | | Exam- | Exam- | Exam- |
|---|---|---|---|---|
| Charge | Ingredients | ple 9 | ple 10 | ple 11 |
| 1 | Photochromic | 9.0 | 9.0 | 9.0 |
| | Blend¹⁰ | | | |
| | Anisole | 23.1 | 40.8 | 40.9 |
| 2 | Example SP-1 | | | 100.5 |
| | Example SP-5 | 98.7 | | |
| | Example SP-6 | | 97.2 | |
| 3 | Alkoxysilane of | 82.4 | | |
| | Example B | | | |
| | Alkoxysilane of | | 65.1 | |
| | Example C | | | |
| | Alkoxysilane of | | | 65.1 |
| | Example D | | | |
| | γ- | 2.0 | 2.9 | 2.0 |
| | glycidoxypropyl- | | | |
| | trimethoxysilane | | | |
| | Triethyl | 11.5 | 10.3 | 12.0 |
| | orthoformate | | | |
| 4 | K-KAT 670¹¹ | 4.0 | 3.9 | 3.9 |

¹⁰A blend of 5 parts photochromic indenofused naphthopyran dyes selected to provide a green-gray color on activation, 2 parts hindered amine light stabilizer and 2 parts hindered phenolic antioxidant.
¹¹A zinc complex catalyst from King Industries.

TABLE 8
Summary of Formulation Details of Examples 4-11

| | | | | | | Weight % |
|---|---|---|---|---|---|---|
| | | | | | Theoretical | Second |
| | Trilkoxysilane | | % Si in | | Hydroxyl | Segment |
| | to Segmented | | Trialkoxysilane | Mw | Value | Based on |
| | Polymer | Trialkoxysilane | (total solids of | Segmented | Segmented | Total Resin |
| Example | Ratio | n= | trialkoxysilane) | Polymer | Polymer | Solids |
| 3 | 65.0:35.0 | 3 | 11.2 | 94200 | 17.8 | 26.0 |
| 4 | 80.0:20.0 | 3 | 11.2 | 94200 | 17.8 | 14.9 |
| 8 | 65.0:35.0 | 3 | 11.2 | 109000 | 11.7 | 29.2 |
| 6 | 65.1:34.9 | 3 | 11.2 | 37400 | 12.9 | 26.3 |
| 7 | 54.2:45.8 | 3 | 11.2 | 49300 | 31.9 | 26.0 |
| 5 | 65.1:34.9 | 3 | 11.2 | 205000 | 6.5 | 28.1 |
| 9 | 65.0:35.0 | 4 | 11.7 | 69400 | 15.5 | 26.6 |
| 10 | 65.1:34.9 | 3 | 7.9 | 131000 | 10.7 | 29.0 |
| 11 | 65.1:34.9 | 2 | 9.8 | 94200 | 17.8 | 25.9 |

The weight percent of the second segment based on (or relative to) the total curable composition was calculated based on the total mass of the second segment, either directly as in the first Comparative Example CE-1 or as a component of the segmented polymer as in the inventive examples.

### Part 5: Preparation of Test Specimens.

The test substrates used to prepare the test specimens were in each case 76 mm diameter PDQ® coated GENTEX® polycarbonate plano lens (commercially available from Gentex Optics, Inc.), which had each been surface treated with oxygen plasma at a flow rate of 100 milliliters (mL) per minute of oxygen at 100 W of power for 3 minutes.

The test substrates were coated with each of the curable photochromic compositions of CE-1, CE-2, and Examples 3-11 by spin coating. About 1 mL to 2 mL of each curable photochromic composition was dispensed onto the test substrate, which was then rotated for 8-32 seconds at a spin speed sufficient to deposit enough wet coating onto the test substrate so as to produce similar activated optical densities (0.298 g to 0.508 g for the examples described herein).

Duplicates of each coated test substrate were prepared for use and evaluation in multiple tests. The coated test substrates were placed in a 40° C. oven until all coated test substrates were accumulated. The 40° C. treated coated test substrates of Comparative Example CE-2 were then cured in a forced air oven at 125° C. for one hour and subsequently cooled to room temperature. The coated test substrates of all other examples were in each case cured in a forced air oven at 40° C. for one hour and subsequently cooled to room temperature; followed by further curing in a forced air oven at 125° C. for fifteen minutes, with subsequent cooling to room temperature. The duplicate test specimens were then split into two groups. The first group was subjected to an additional thermal cure at 105° C. for three hours, and set aside for evaluation of surface hardness. Prior to application of a protective coating there-over as described in the next paragraph the test specimens of the second group were evaluated for % Haze on a HunterLab UltraScan® PRO, commercially available from Hunter Associates Laboratory, Inc. The % Haze was measured using D65 as the standard illuminant and 10° viewing angle.

After the % Haze measurements were completed the test specimens of the second group were then further surface treated with oxygen plasma as previously described with regard to the test substrates above, and spin coated with a protective coating according to the formulation reported in Table 1 of Example 1 in U.S. Pat. No. 7,410,691. The applied protective coating was UV cured in an EyeUV oven equipped with D bulbs and then further cured at 105° C. for three hours. The protective coated test specimens of the second group were then evaluated for photochromic properties.

### Part 6: Test Methods and Test Results of the Test Specimens.

Test specimens of the first group were subjected to microhardness testing using a Fischerscope® HM2000 S apparatus (commercially available from Fischer Technology, Inc.) at a penetration depth of 2 microns, after a 100 Newton load for 30 seconds. Each test specimen was measured at least 2 times and the microhardness results were averaged.

The photochromic performance of the protective coated test specimens of the second group was determined using a Bench for Measuring Photochromics (“BMP”) made by Essilor, Ltd. France. The BMP was maintained at a constant temperature of 23° C. during testing. Prior to testing on the BMP, each of the test specimens was exposed to 365 nm ultraviolet light for about 10 minutes at a distance of about 14 centimeters to activate the photochromic materials. The UVA (315 nm to 380 nm) irradiance of the test specimen was measured with a LICOR® Model Li-1800 spectroradiometer and found to be 22.2 W/m². Each test specimen was then placed under a 500 W, high intensity halogen lamp for about 10 minutes at a distance of about 36 centimeters to bleach (inactivate) the photochromic materials. The illuminance at the test specimen was measured with the LICOR® spectroradiometer and found to be 21.9 Klux. Each test specimen was then kept in a dark environment at room temperature (from 21° C. to 24° C.) for at least one hour prior to testing on the BMP. Prior to measurement, each test specimen was measured for ultraviolet absorbance at 390 nm.

The BMP was fitted with two 150 W Newport model #6255 Xenon arc lamps set a right angles to each other. The light path from Lamp 1 was directed through a 3 mm SCHOTT® KG-2 band-pass filter and appropriate neutral density filters that contributed to the required UV and partial visible light irradiance level. The light path from Lamp 2 was directed through a 3 mm SCHOTT® KG-2 band-pass filter, a SCHOTT® short band 400 nm cutoff filter, and appropriate neutral density filters in order to provide supplemental visible light illuminance. A 2 inch×2 inch (5.1 cm×5.1 cm) 50% polka dot beam splitter set at 450 to each lamp is used to mix the two beams. The combination of neutral density filters and voltage control of the Xenon arc lamp were used to adjust the intensity of the irradiance. Software (BMPSoft version 2.1e) was used on the BMP to control timing, irradiance, air cell and sample temperatures, shuttering, filter selection, and response measurement. A ZEISS® spectrophotometer, Model MCS 601 with fiber optic cables for light delivery through the lens, was used for response and color measurement. Photopic response measurements were collected on each protective coated test specimen of the second group.

The power output of the BMP (i.e., the dosage of light that the test specimen was exposed to) was adjusted to 6.7 W/m² UVA, integrated from 315-380 nm, and 50 Klux illuminance, integrated from 380-780 nm. Measurement of this power set-point was made using an irradiance probe and the calibrated ZEISS® spectrophotometer. The test specimen sample cell was fitted with a quartz window and self-centering sample holder. The temperature in the sample cell was controlled at 23° C. through the software with a modified Facis, Model FX-10 environment simulator. Measurement of the dynamic photochromic response and color of the test specimen were made using the same ZEISS® spectrophotometer with fiber optic cables for light delivery from a tungsten halogen lamp through the sample. The collimated monitoring light beam from the fiber optic cable was maintained perpendicular to the test sample while passing through the test specimen and directed into a receiving fiber optic cable assembly attached to the spectrophotometer. The exact point of the placement of the test specimen in the sample cell was where the activation xenon arc beam and the monitoring light beam intersected to form two concentric circles of light. The angle of incidence of the xenon arc beam at the test specimen placement point was about 30° from perpendicular.

Response measurements, in terms of a change in optical density (ΔOD) from the unactivated (bleached) state to the activated (colored) state, were determined by establishing the initial unactivated transmittance then opening the shutter from the Xenon arc lamp(s) and measuring the transmittance through activation at selected intervals of time. Change in optical density was determined according to the following equation (Eq. C):

$$Δ OD = {Log}_{10} ( \% Tb / \% Ta ) \qquad Eq . C$$

With reference to Eq. C, % Tb is the percent transmittance in the bleached state and % Ta is the percent transmittance in the activated state. Optical density measurements were based on photopic optical density.

The results of the microhardness, haze, Fade Half Life (T_{1/2}), Fade Third Half Life (T_{7/8}), Fade Fourth Half Life (T_{15/16}), and ΔOD at saturation testing are summarized in Tables 9 through 11. The ΔOD at saturation values, as tabulated, are each after 15 minutes of activation.

The Fade Half Life (T_{1/2}) values are in each case the time interval in seconds for the ΔOD of the activated form of the photochromic material in the coating to reach one half the saturated ΔOD at 23° C., after removal of the activating light source. The Fade Third Half Life (T_{7/8}) values are in each case the time interval in seconds for the ΔOD of the activated form of the photochromic material in the coating to reach one eighth of the saturated ΔOD at 23° C., after removal of the activating light source. The Fade Fourth Half Life (T_{15/16}) values are in each case the time interval in seconds for the ΔOD of the activated form of the photochromic material in the coating to reach one sixteenth of the saturated ΔOD at 23° C., after removal of the activating light source.

TABLE 9

| | Fischer | | T_{1/2} @ | T_{7/8} @ | T_{15/16} @ | |
|---|---|---|---|---|---|---|
| | Microhardness | % Haze | Photopic | Photopic | Photopic | ΔOD at |
| Example | (N/mm²) | (D65/10°) | (seconds) | (seconds) | (seconds) | Saturation |
| CE-1 | 12 | 4.64 | 48 | 194 | 317 | 0.88 |
| CE-2 | 41 | 0.13 | 50 | 217 | 448 | 0.87 |
| Example 3 | 54 | 0.19 | 49 | 188 | 297 | 0.90 |
| Example 4 | 69 | 0.16 | 54 | 228 | 424 | 0.88 |

With reference to Table 9, Comparative Example CE-1 is directly comparable to inventive Example 3, wherein the second segment is present in the same amount, but in CE-1, the second segment is present in place of (or in the absence) the segmented polymer of Example 3. The resulting CE-1 coating, using the same trialkoxysilane functional material, is significantly softer and hazier. Likewise, CE-2 is directly comparable to Example 3, in that the same segmented polymer is used in both at comparable levels, but comparing a trifunctional isocyanate matrix (CE-2) to a trifunctional trialkoxysilane matrix (Example 3). Although haze is acceptable for both CE-2 and Example 3, the trialkoxysilane coating has higher hardness coupled with faster fade. This is particularly demonstrated by the later stage (T_{7/8} and T_{15/16}) fade rates. In fact, as shown with Example 4, the segmented polymer when present at a much lower amount (as is the second segment of the segmented polymer) when compared to the trifunctional isocyanate matrix (CE-2), provides a significantly harder coating, but at the same time having comparable fade rates using the same segmented polymer.

TABLE 10

| | Fischer | % Haze | T_{1/2} @ | T_{7/8} @ | T_{15/16} @ | |
|---|---|---|---|---|---|---|
| | Microhardness | (D65/10°)- | Photopic | Photopic | Photopic | ΔOD at |
| Example | (N/mm²) | no top coat | (seconds) | (seconds) | (seconds) | Saturation |
| Example 3 | 54 | 0.19 | 49 | 188 | 297 | 0.90 |
| Example 4 | 69 | 0.16 | 54 | 228 | 424 | 0.88 |
| Example 5 | 41 | 0.15 | 49 | 206 | 373 | 0.89 |
| Example 6 | 51 | No visible | 49 | 198 | Not | 0.90 |
| | | haze¹⁶ | | | measured | |
| Example 7 | 48 | 0.12 | 53 | 228 | 454 | 0.88 |
| Example 8 | 31 | 0.25 | 45 | 168 | Not | 0.88 |
| | | | | | measured | |

¹⁶Where no visible haze is indicated, the haze value was considered to be less than 0.5.
Typically, haze values of less than 0.5 are not visually observable.

The results as tabulated in Table 10 demonstrate the effect of varying the characteristics of the segmented polymer with respect to the hydroxyl value and molecular weight (Mw) as well as the total amount of segmented polymer and/or second segment. It is shown that hard, haze-free coatings are obtained within a broad range of segmented polymer Mw while maintaining good photochromic performance. Examples 3 through 7 include a fluorinated first segment, while Example 8 include an acrylic first segment.

TABLE 11

| | Fischer | % Haze | T_{1/2} @ | T_{7/8} @ | T_{15/16} @ | |
|---|---|---|---|---|---|---|
| | Microhardness | (D65/10°)- | Photopic | Photopic | Photopic | ΔOD at |
| Example | (N/mm²) | no top coat | (seconds) | (seconds) | (seconds) | Saturation |
| Example 9 | 41 | No visible | 49 | 207 | Not | 0.92 |
| | | haze¹⁶ | | | measured | |
| Example 10 | 38 | No visible | 50 | 225 | 491 | 0.79 |
| | | haze¹⁶ | | | | |
| Example 11 | 30 | No visible | 54 | 264 | Not | 0.81 |
| | | haze¹⁶ | | | measured | |

¹⁶Where no visible haze is indicated, the haze value was considered to be less than 0.5.
Typically, haze values of less than 0.5 are not visually observable.

The results as summarized in Table 11 provide a comparison of coatings prepared from curable photochromic compositions according to the present invention that include different trialkoxysilane functional materials. Each such inventive curable photochromic coating composition provides haze-free coatings having good hardness and photochromic performance.

The present invention has been described with reference to specific details of particular embodiments thereof. It is not intended that such details be regarded as limitations upon the scope of the invention except insofar as to the extent that they are included in the accompanying claims.

What is claimed is:

1. A curable photochromic composition comprising:
(a) a photochromic compound;
(b) a trialkoxysilane functional material having at least two trialkoxysilane groups; and
(c) a segmented polymer comprising, at least one first segment, and at least one second segment, wherein,
(i) each first segment independently comprises at least one of a (meth)acrylic polymer segment, or a fluoroethylene vinyl ether polymer segment, and
(ii) each second segment independently comprises at least one of, a polycarbonate segment, a polyester segment, a polyether segment, or a polyurethane segment.

2. The curable photochromic composition of claim 1, wherein the first segment comprises hydroxyl groups.

3. The curable photochromic composition of claim 1, wherein the segmented polymer has a hydroxyl number of less than 35.

4. The curable photochromic composition of claim 1, wherein the second segment is present in the segmented polymer in an amount of from 50 percent by weight to 90 percent by weight, based on total weight of the segmented polymer.

5. The curable photochromic composition of claim 1, wherein the segmented polymer has a Mw of 35,000 to 250,000.

6. The curable photochromic composition of claim 1, wherein each second segment independently comprises, the polycarbonate segment, a polycarbonate-polyester segment, a polycarbonate-polyurethane segment, and a polycarbonate-polyester-polyurethane segment.

7. The curable photochromic composition of claim 1, wherein the trialkoxysilane functional material is represented by the following Formula (I), 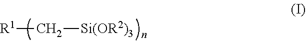
wherein n is at least 2,
each R² is independently methyl or ethyl, and
R¹ comprises at least one of,
a polyvalent aliphatic hydrocarbon residue,
a polyvalent aliphatic ether residue,
a polyvalent aliphatic urethane residue,
a polyvalent aliphatic carboxylic acid ester residue, or
a polyvalent aliphatic carbonate residue.

8. The curable photochromic composition of claim 7, wherein n of Formula (I) is from 2 to 4.

9. The curable photochromic composition of claim 7, wherein R¹ comprises at least one of polyvalent aliphatic hydrocarbon residue, polyvalent aliphatic urethane residue, or polyvalent aliphatic carbonate residue.

10. The curable photochromic composition of claim 1, wherein the trialkoxysilane functional material comprises Si in an amount of from 5.0 to 16.0 percent by weight, based on solids weight of the trialkoxysilane functional material.

11. The curable photochromic composition of claim 1, wherein a weight ratio of the trialkoxysilane functional material to the segmented polymer is from 80:20 to 50:50.

12. The curable photochromic composition of claim 11, wherein the weight ratio of the trialkoxysilane functional material to the segmented polymer is from 75:25 to 60:40.

13. The curable photochromic composition of claim 1, wherein the curable photochromic composition comprises a total amount of second segments of from 10 percent by weight to 45 percent by weight, based on total solids weight of the curable photochromic composition.

14. The curable photochromic composition of claim 1, further comprising a catalyst that catalyzes the formation of siloxane linkages.

15. An article comprising:
(A) a substrate; and
(B) a photochromic layer over at least one surface of the substrate, wherein the photochromic layer is formed from the curable photochromic composition of claim 1.
